(19) United States
(12) Patent Application Publication
(10) Pub. No.: US 2024/0325988 A1
(43) Pub. Date: Oct. 3, 2024

(54) POLYSULFONE-BASED MEMBRANE FOR FRACTIONATION OF ERICHROME BLACK T (EBT)/DIVALENT SALTS, AND A METHOD OF MAKING THE SAME

(71) Applicant: KING FAHD UNIVERSITY OF PETROLEUM AND MINERALS, Dhahran (SA)

(72) Inventors: Nadeem BAIG, Dhahran (SA); Asif MATIN, Dhahran (SA); Irshad AHMAD, Dhahran (SA); Safyan Akram KHAN, Dhahran (SA)

(73) Assignee: KING FAHD UNIVERSITY OF PETROLEUM AND MINERALS, Dhahran (SA)

(21) Appl. No.: 18/192,110

(22) Filed: Mar. 29, 2023

(51) Int. Cl. B01D 69/10; B01D 61/02; B01D 67/00; B01D 69/02; B01D 69/12; B01D 69/14; B01D 71/02; B01D 71/60; B01J 20/02; B01J 20/26; B01J 20/28; B01J 20/30; B01J 20/32; C02F 1/44

(52) U.S. Cl. CPC B01D 69/1071; B01D 61/027; B01D 67/00793; B01D 69/02; B01D 69/1214; B01D 69/148; B01D 71/022; B01D 71/60; B01J 20/0233; B01J 20/262; B01J 20/28007; B01J 20/28035; B01J 20/28083; B01J 20/28085; B01J 20/3071; B01J 20/3085; B01J 20/3212; B01J 20/3214; B01J 20/3272; B01J 20/3295; C02F 1/442; B01D 2323/48; B01D 2325/02832; B01D 2325/06; C02F 2101/308

(57) ABSTRACT

A membrane includes a polysulfone-based support, a polydopamine (PDA) layer disposed on a surface of the polysulfone-based support, and a silver/polydopamine (Ag/PDA) composite layer disposed on a surface of the polydopamine layer. The polysulfone-based support has a pore size of up to 600 nanometers (nm). The Ag/PDA composite layer contains core-shell structure particles and spherical particles. The core-shell structure particles have a silver nanoparticle core and a polydopamine shell. The spherical particles are silver-decorated polydopamine particles. The membrane can at least partially separate an Erichrome Black T (EBT) dye from an EBT dye/salt containing mixture by rejecting the EBT dye and allowing the EBT dye/salt containing mixture to pass through the membrane.

### STATEMENT REGARDING PRIOR DISCLOSURE BY THE INVENTORS

Aspects of this technology are described in “Antifouling low-pressure highly permeable single step produced loose nanofiltration polysulfone membrane for efficient Erichrome Black T/divalent salts fractionation,” Journal of Environmental Chemical Engineering, Volume 10, Issue 4, 108166, which is incorporated herein by reference in its entirety.

### STATEMENT OF ACKNOWLEDGEMENT

This research was supported by the IRC membrane & water security at King Fahd University of Petroleum & Minerals (KFUPM).

### BACKGROUND

### Technical Field

The present disclosure is directed to a membrane, particularly a polysulfone-based membrane for fractionation of Erichrome Black T (EBT)/divalent salts, and a method of making the polysulfone membrane.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

The global water crisis has been exacerbated by increasing population, rapid industrialization, urbanization, and improving health standards. Wastewater reclamation and reuse are potential sources for augmenting the existing freshwater supplies. However, reclaiming and reusing wastewater is a challenging process due to the complex mixture of organic compounds, dyes, and inorganic matter found in domestic and industrial waste streams from various sources. Dyes are extensively used in the textile, paper, plastics, cosmetics, pharmaceuticals, and food industries, resulting in a massive discharge of textile wastewater globally, with around 700,000 tonnes of synthetic dyes used annually. Most dyes are not readily biodegradable due to their complex aromatic structure and synthetic origins, which results in acute and chronic toxicity. EBT is a hydroxyl-arylazo dye found in wastewater streams from the textile industry. It is widely used in the textile industry to color fabrics such as nylon, wool, and silk, as well as in research and teaching laboratories as a metallochromic indicator in titration complexation to determine water hardness. Erichrome Black T (EBT) belongs to the group of organic dyes that are tough to degrade due to the complexity of their structures. EBT resists degradation even when present in low concentrations and is tough to eliminate due to its resistance to microbes, heat, chemicals, and light. Azo dyes are stable and typically degrade at temperatures higher than 200° C., producing naphthylamine, a highly toxic carcinogen that can be absorbed through the skin to generate methemoglobin resulting in blood poisoning. In addition, naphthylamine is harmful to aquatic life and considered mutagenic, causing chronic effects after prolonged exposure.

Due to the serious environmental and health hazards associated with the EBT dye, researchers have investigated various strategies for its effective removal from wastewater. These include adsorption, coagulation-flocculation, and oxidation techniques. Adsorption has been the focus of many researchers due to its ease of use, with a wide variety of adsorbents such as steel slag-based adsorbent, montmorillonite (MM) raw clay, nanomaterials, and polymeric nanocomposites being used. For the oxidation of the dye, various processes such as the Fenton, ozonation, electrochemical oxidation, and photocatalysis are explored. A combination of electrocoagulation/electroflotation has resulted in a removal efficiency of over 98% within an hour. However, each of these techniques has some inherent drawbacks and limitations associated with it. For example, the adsorption process can be discontinuous and difficult to use with large volumes of water, while coagulation-flocculation and oxidation techniques are tedious and require expensive chemicals and sophisticated equipment.

Due to their high retention capabilities, ease of operation, and lower economic liability, membrane-based dye removal presents a more feasible alternative to the aforementioned technologies. Membranes are used for water treatment applications, such as seawater, brackish water, oil/water separation, and wastewater treatment. Based on the average pore size, membrane processes can be categorized as ultrafiltration, nanofiltration, and reverse osmosis. Nanofiltration is a technology that can efficiently remove dyes and organic pollutants. The nanofilter (NF) membranes used in this technique are classified as either tight or loose NF, with pore size in the range of approximately 0.5-2 nm and 3-8 nm, respectively. The major challenge associated with the membranes is their rapid fouling during the separation of dyes. EBT rapidly adsorbs on the membrane's surface, resulting in severe fouling and a decline in flux. This makes the membrane-based dye removal process energy-intensive and unfavorable to be applied on a large scale. Additionally, the treatment of several wastewaters, such as textile waste, requires fractionating dye/salt mixtures. Commercial NF membranes that fall under the tight category become unsuitable because of retaining a high percentage of divalent ions together with the dye. Thus, the commercially available NF membranes have exhibited high retention of organic molecules and multivalent ions and substantially low retention or high permeability for the monovalent ions. For example, the commercial NF membranes DK & CK (Osmonics) used for removing reactive EBT have shown rejections over 98% and over 92% for MgSO₄ and Na₂SO₄, respectively. Therefore, it is necessary to control the membrane surface characteristics, such as pore size and hydrophilicity, more precisely to achieve effective dye/salt fractionation and reasonable flux. The membranes are designed to show high rejection of the dyes and salts during the textile wastewater treatment. The co-existence of the dyes and salts in textile wastewater treatment causes problems in the post-treatment process. Alternatively, as dyes are not eco-friendly, it is preferable to collect them for future use. Therefore, it is critical to separate the salts from the dye solution. Several membranes are reported for the fractionization of dyes/salts. Loose nanofiltration (NF) hollow fiber membrane with ultrahigh water permeability has been reported with the Na₂SO₄ rejection of less than 10%. Similarly, the PA/PVDF composite hollow fiber membranes reported a high rejection of EBT and low salt rejection of NaCl (6.2%). The loose nanofiltration membranes are more effective in separating monovalent salts, or when at least one of the ions is monovalent, and dyes. However, their separation efficiency is not as high when it comes to divalent salts. The nanofiltration membranes are considered more effective in removing the divalent salts compared to the monovalent ones. Hence, fabricating NF membranes with precise control is necessary to allow the passage of most divalent salt ions and, at the same time, achieve almost complete rejection of the dye.

In view of the forgoing, one objective of the present disclosure is to provide a membrane with high dye/salt fractionation ability and good anti-fouling characteristics. A further objective of the present disclosure is to describe a method of making the membrane. A third objective of the present disclosure is to describe a water treatment method.

### SUMMARY

In an exemplary embodiment, a membrane is disclosed. The membrane includes a polysulfone-based support, a polydopamine (PDA) layer disposed on a surface of the polysulfone-based support, and a silver/polydopamine (Ag/PDA) composite layer disposed on a surface of the polydopamine layer. In some embodiments, the polysulfone-based support has a pore size up to 600 nanometers (nm). In some embodiments, the Ag/PDA composite layer includes core-shell structure particles and spherical particles. In some embodiments, the core-shell structure particles have a silver nanoparticle core and a polydopamine shell. In some embodiments, the spherical particles are silver-decorated polydopamine particles. In some embodiments, the membrane can at least partially separate an Erichrome Black T (EBT) dye from an EBT dye/salt containing mixture by rejecting the EBT dye and allowing the EBT dye/salt containing mixture to pass through the membrane.

In some embodiments, the membrane has a pore size in a range of 3 to 8 nanometers (nm).

In some embodiments, the polysulfone-based support includes at least one polymer selected from the group consisting of a polysulfone, a polyethersulfone, and a polyarylethersulfone.

In some embodiments, the polysulfone-based support is a polysulfone polymer in the form of a membrane having a contact angle of 50 to 80 degrees (°).

In some embodiments, the core-shell structure particles and the silver-decorated polydopamine particles are uniformly disposed on the surface of the polydopamine layer.

In some embodiments, the silver-decorated polydopamine particles have a particle size in a range of 50 to 900 nm.

In some embodiments, the silver-decorated polydopamine particles are decorated with Ag nanoparticles immobilized on a surface of the spherical particles.

In some embodiments, the membrane has a contact angle of 20 to 30°.

In some embodiments, the membrane has a permeate flux of 30 to 50 liters per square meter per hour per bar (L m⁻²h⁻¹bar⁻¹).

In some embodiments, the membrane has an average surface roughness (Rₐ) of 30 to 80 nm.

In some embodiments, the membrane has enhanced anti-fouling properties compared to a polysulfone membrane as determined by bovine serum albumin (BSA) test.

In an exemplary embodiment, a method of making the membrane is also disclosed. The method includes adjusting the pH of a dopamine solution to 8 to 11 with a base to polymerize dopamine monomers present in the dopamine solution and form the polydopamine. The method includes dipping the polysulfone-based-support in the dopamine solution for at least 10 minutes to form a polydopamine-coated sample. The method further includes dropwise adding a silver salt solution to the dopamine solution containing the polydopamine coated sample and agitating the polydopamine coated sample in the dopamine solution for at least 4 hours to form a crude sample. The method further includes removing the crude sample from the dopamine solution, washing, and drying to form the membrane. In some embodiments, the silver salt reacts with the dopamine and the polydopamine to form the Ag/PDA composite layer disposed on the surface of the polydopamine coated sample.

In some embodiments, the base is at least one selected from the group consisting of NaOH, KOH, LiOH, and Ca(OH)₂.

In some embodiments, the polysulfone-based support is a polysulfone polymer in the form of a membrane having a contact angle of 60 to 70°.

In some embodiments, the silver salt is at least one selected from the group consisting of silver nitrate, silver sulfate, silver carbonate, and silver chloride.

In some embodiments, dopamine is present in the dopamine solution at a concentration of 0.05 to 1 wt. % based on a total weight of the dopamine solution.

In some embodiments, the silver salt is present in the silver salt solution at a concentration of 0.0001 to 0.01 M.

In some embodiments, the polysulfone-based support is a polysulfone membrane. The polysulfone membrane is prepared by mixing and dissolving solid particles of polysulfone in an amide solvent and de-gassing to form a polysulfone solution. The polysulfone is present in the polysulfone solution at a concentration of 5 to 40 wt. % based on the total weight of the polysulfone solution. The method further includes drop casting the polysulfone solution on a non-woven support to form a sample. The method of preparing the polysulfone membrane involves dipping the sample in water to form the polysulfone membrane on the non-woven support. The method of preparing the polysulfone membrane further involves removing the polysulfone membrane from the non-woven support, washing, and drying.

In an exemplary embodiment, a water treatment method is described. The method includes contacting a contaminated aqueous composition containing one or more organic dyes and one or more salts with the membrane to adsorb the organic dyes on the membrane and form a purified aqueous composition.

In some embodiments, the one or more salts comprise one or more divalent ions selected from the group consisting of Ca²⁺, Cu²⁺, Ni²⁺, Mg²⁺, Zn²⁺, Ba²⁺, Fe²⁺, and Sr²⁺.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of making a membrane, according to certain embodiments;

FIG. 2 is a schematic illustration of the membrane fabrication and installation steps into a cross-flow system to evaluate separation efficiency, according to certain embodiments;

FIG. 3 depicts a mechanism of initiation and formation of the polydopamine (PDA) on a surface of the membrane, according to certain embodiments;

FIG. 4 depicts Fourier Transform Infrared (FTIR) spectra and footprint region magnified for various membranes, according to certain embodiments;

FIG. 5 depicts contact angle values and droplet images for the various membranes, according to certain embodiments;

FIG. 6A-FIG. 6C depict scanning electron microscopic (SEM) images of the membranes modified with silver nanoparticles—the membranes are exposed to dopamine solution for 6 hours (AD6), according to certain embodiments;

FIG. 6D-FIG. 6F depict scanning electron microscopic (SEM) images of the membranes modified with silver nanoparticles—the membranes are exposed to dopamine solution for 12 hours, according to certain embodiments (AD12);

FIG. 7A depicts a two-dimensional (2D) and atomic force microscopic (AFM) image of a pristine polysulfone (PS) membrane, according to certain embodiments;

FIG. 7B depicts a three-dimensional (3D) AFM image of pristine PS membrane, according to certain embodiments;

FIG. 7C depicts a 2D AFM image of a polysulfone membrane exposed to dopamine solution for 6 hours (D6), according to certain embodiments;

FIG. 7D depicts a 3D AFM image of a D6 membrane, according to certain embodiments;

FIG. 7E depicts a 2D AFM image of a polysulfone membrane exposed to dopamine solution for 12 hours (D12), according to certain embodiments;

FIG. 7F depicts a 3D AFM image of a D12 membrane, according to certain embodiments;

FIG. 7G depicts a 2D AFM image of a polysulfone membrane immobilized with silver nanoparticles in dopamine solution for 12 hours (AD12), according to certain embodiments;

FIG. 7H depicts a 3D AFM image of the AD12 membrane, according to certain embodiments;

FIG. 8A depicts a high-resolution X-ray photoelectron spectroscopy (XPS) of C1s for the membrane (polysulfone membrane immobilized with silver and polydopamine-L-Ag-PDA-PS), according to certain embodiments;

FIG. 8B depicts a high-resolution X-ray photoelectron spectroscopy (XPS) of Ag 3d for the L-Ag-PDA-PS-membrane, according to certain embodiments;

FIG. 8C depicts a high-resolution X-ray photoelectron spectroscopy (XPS) of N1s for the L-Ag-PDA-PS-membrane, according to certain embodiments;

FIG. 8D depicts a high-resolution X-ray photoelectron spectroscopy (XPS) of O1s for the L-Ag-PDA-PS-membrane, according to certain embodiments;

FIG. 9 depicts a plot depicting a permeate flux for the various membranes with de-ionized (DI) water as feed, according to certain embodiments;

FIG. 10A is a plot depicting the permeate flux for the various membranes, at different applied pressures, according to certain embodiments;

FIG. 10B is a plot depicting a percentage of dye rejection with the various membranes, at different applied pressures, according to certain embodiments;

FIG. 11 depicts a chemical structure of EBT dye, according to certain embodiments;

FIG. 12A depicts optical images of feed and permeate with the various membranes, according to certain embodiments;

FIG. 12B depicts an ultraviolet-visible (UV-Vis) spectra of feed and permeate with the various membranes, according to certain embodiments;

FIG. 13 is a plot depicting percentage rejection of dye and divalent salt for the various membranes, according to certain embodiments;

FIG. 14 is a plot depicting a variation of normalized flux with time for the various membranes in a feed containing 25 ppm each of bovine serum albumin (BSA) and EBT, according to certain embodiments;

FIG. 15 is a plot depicting a percentage rejection of the EBT dye for the various membranes after 6 hours, at a pressure of 2 bars, according to certain embodiments;

FIG. 16A-FIG. 16C depict SEM images of polysulfone membrane, at different magnifications, after exposure to bacterial suspension of P. aeruginosa. in static conditions, according to certain embodiments;

FIG. 16D-FIG. 16F depict SEM images of polysulfone membrane coated with polydopamine for 6 hours, at different magnifications, after exposure to bacterial suspension of P. aeruginosa. in static conditions, according to certain embodiments;

FIG. 16G-FIG. 16I depict SEM images of the polysulfone membrane immobilized with Ag/polydopamine, at different magnifications, after exposure to bacterial suspension of P. aeruginosa. in static conditions, according to certain embodiments; and

FIG. 17 is a schematic illustration depicting a formation of loose filtration layer through various combinations of Ag/polydopamine on a surface of the polysulfone membrane and the separation principle for the various membranes, according to certain embodiments.

### DETAILED DESCRIPTION

In the drawings, reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

To effectively fractionate dyes and divalent salts, there is a high demand for loose nanofiltration (NF) membranes with high permeability, as nanofiltration membranes are unable to separate these components. Aspects of the present disclosure are directed to a facile surface modification of an ultrafiltration (UF) membrane (polysulfone) with a loose layer of nanosilver-immobilized polydopamine. This was achieved by initiating the polymerization of the dopamine on the PS membrane and in situ immobilization of the Ag and dopamine to form a loose separating layer on the surface of the membrane (L-Ag-PDA-PS-membrane).

A membrane is described. The membrane can at least partially separates a dye, preferably an EBT dye, from a dye/salt-containing mixture by rejecting the dye and allowing the dye/salt-containing mixture to pass through the membrane. In some embodiments, at least 50% of the dye molecules are rejected based on a total number of the dye molecyes in the dye/salt-containing mixture before contacting with the membrane, preferably at least 60%, preferably at least 70%, preferably at least 80%, preferably at least 90%, or even more preferably at least 95% of the dye molecules are rejected based on the total number of the dye molecules in the dye/salt-containing mixture. Although the description and examples herewith provided refer to the use of the membrane to separate the EBT dye from a dye/salt mixture, it may be noted that aspects of the present disclosure may be applied to separating other azo dyes as well, such as methylene, albeit with a few variations, as may be evident to a person skilled in the art.

In some embodiments, the membrane includes a polysulfone-based support, which acts as a supporting layer. The performance of the membrane is dependent on the properties of the supporting layer. In some embodiments, the polysulfone-based support may include one or more polymers selected from a polysulfone (PSU), a polyethersulfone (PES/PESU), and a polyphenylene sulfone (PPSU). In an embodiment, the support layer may be made of one or more layers, where each layer may include repeating units of the same polymer or a different polymer. In an embodiment, the support layer may contain a first layer and a second layer. In some embodiments, the first layer and the second layer may include different polymers. In some embodiments, the first layer may include PSU, and the second layer may include PES. Each layer may be made up of the same/different pore sizes. In some embodiments, the support layer may include copolymers selected from the group consisting of a polyether, and a polyester carbonate. In some further embodiments, the support layer may also include a non-reactive polymer selected from the group consisting of a polyvinylpyrrolidone (PVP), and a polyethylene oxide (PEO). In some preferred embodiments, the support layer is a polysulfone polymer. In some more preferred embodiments, the polysulfone-based support has a pore size of up to 600 nanometers (nm), preferably up to 500 nm, preferably up to 400 nm, preferably up to 300 nm, preferably up to 200 nm, or even more preferably up to 100 nm. Other ranges are also possible.

The membrane further includes a polydopamine (PDA) layer disposed on the surface of the polysulfone-based support. In some embodiments, the PDA may be optionally substituted by various functional groups such as lower alkyl groups, alkenyl groups, amino groups, aryl groups, alkyl aryl groups, halogen groups, halo groups, haloalkyl groups, phosphoryl groups, or a combination thereof. In some embodiments, PDA may non-specifically adhere to virtually any surface with which it comes into contact. In some embodiments, the deposition of the PDA on the polysulfone membrane occurs by dissolving dopamine in an alkaline water solution (e.g., from a pH of about 8 to a pH of 14) and then immersing the polysulfone membrane into the dopamine solution for an appropriate period of time. In a preferred embodiment, the pH of the dopamine solution was between 8 to 11, more preferably about 8.5. In some embodiments, the duration of exposure of the support layer to the dopamine solution may be varied depending on the amount of dopamine that is to be deposited on the membrane. In some embodiments, the polysulfone membrane is in contact with the dopamine solution for a period of 4-20 hours, preferably 4-15 hours, preferably 6-12 hours. In some embodiments, the time period of immersion of the support layer in the dopamine solution may be varied based on various factors-such as concentration of dopamine, pH of the dopamine solution, type of support layer, temperature, etc.

The membrane further includes a silver/polydopamine (Ag/PDA) composite layer (also referred to as a composite layer) disposed on the surface of the PDA layer. The composite layer includes core-shell structure particles and spherical particles. In some embodiments, the core-shell structure particles contain a solid core with one or more layers of shell deposited around the core. In an embodiment, the silver nanoparticles form the core. Optionally, the core may include other metal nanoparticles, such as iron, zirconium, silica, aluminum, titanium, and magnesium. gold, platinum (Pt), and palladium (Pd). In some further embodiments, the core is surrounded by one or more layers of the shell. The PDA forms the shell. In some preferred embodiments, the degree of functionalization with silver nanoparticles may be controlled by various factors, such as time and concentration of silver in silver nitrate solution. In some more preferred embodiments, the composite layer further includes spherical particles that are silver-decorated polydopamine particles. In some more preferred embodiments, the core-shell structure particles and the silver-decorated polydopamine particles are uniformly disposed on the surface of the polydopamine layer. In some most preferred embodiments, the silver-decorated polydopamine particles are decorated with Ag nanoparticles immobilized on a surface of the spherical particles.

The membrane may be characterized by FTIR, SEM, XPS, AFM, and contact analyzer. In an embodiment, the polysulfone-based support has a contact angle of 50 to 80°, preferably 60 to 70°, or preferably about 65°. In an embodiment, rejection for the EBT dye and dye/salt fractionation efficiencies for the membrane is determined by a filtration test method. In some embodiments, fouling experiments may be conducted under static and dynamic conditions. The static condition may include a gram-negative bacteria species, and the dynamic condition may include BSA in a cross-flow operating mode. In some further embodiments, long-term fouling experiment is conducted in the presence of BSA. The membrane of the present disclosure fractionates the dye from a dye/divalent salts containing mixture.

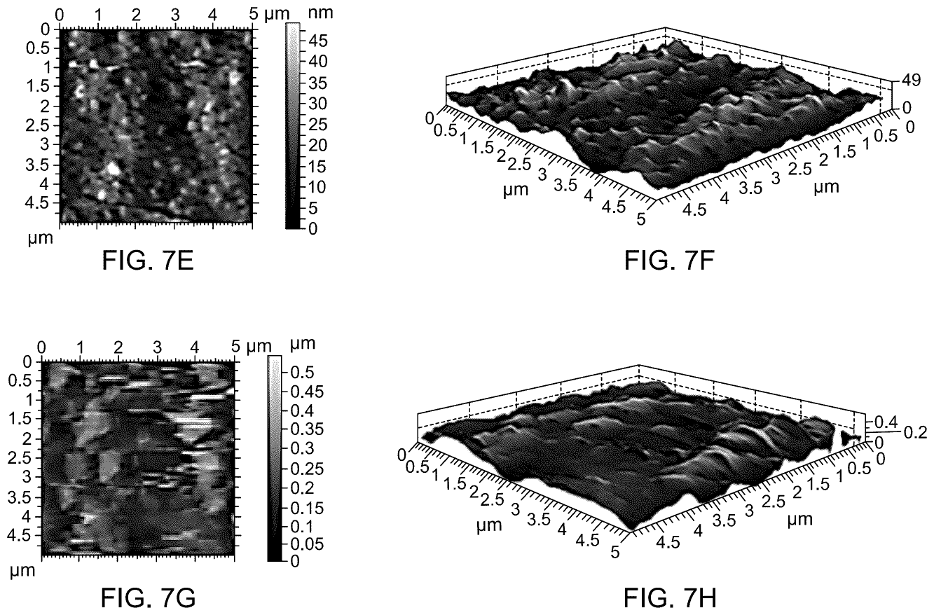

FIG. 8A to 8D illustrate high-resolution X-ray photoelectron spectroscopy (XPS) spectra of C1s, Ag 3d, N1s, and O1s. In some embodiments, the XPS is conducted on a ESCALAB 250Xi at a binding energy of 100 to 800 electronvolts (eV), preferably 200 to 600 eV. In some embodiments, C1s of the membrane has a first binding energy peak of about 284.37 eV, a second binding energy peak of about 285.88 eV, a third binding energy peak of about 287.69 eV, and a fourth binding energy peak of about 291.33 eV, as depicted in FIG. 8A. In some further embodiments, Ag 3d of the membrane has a first binding energy peak of about 367.92 eV to about 368.54 eV, and a second binding energy peak of about 373.89 to about 374.47 eV, as depicted in FIG. 8B. In some preferred embodiments, N1s of the membrane has a binding energy peak of about 398.8 eV to about 399.9 eV, as depicted in FIG. 8C. In some more preferred embodiments, O1s of the membrane has a first binding energy peak of about 530.72 eV, and a second energy peak of about 532.9 eV, as depicted in FIG. 8D. Other ranges are also possible.

As used herein, the term “contact angle,” or “water contact angle” generally refers to an average water contact angle (i.e., contact angles measured by Sessile Drop method) at room temperature. The result is obtained by averaging measurements of contact angles with at least 3 individual contact lenses. The water contact angle may be recorded on a Drop Shape Analyzer (DSA25, KRÜSS). In some embodiments, the membrane sample was cut into pieces of about 1 cm×1 cm, and the contact angle was measured by placing 5 μL water drop on a surface of the membrane sample.

In some embodiments, the membrane of the present disclosure has a contact angle of 20 to 30 degrees, indicating this hydrophilic nature, preferably 22 to 28°, preferably 24 to 26°, or even more preferably about 25°. Other ranges are also possible. In some further embodiments, the membrane has a permeate flux of 30 to 50 liters per square meter per hour per bar (L m⁻²h⁻¹bar⁻¹), preferably 35 to 45 LMH, or even more preferably about 40 LMH. Other ranges are also possible.

As used herein, the term “surface roughness,” or “Rₐ surface roughness,” or “Rₐ” generally refers to arithmetical mean roughness of a surface, which measures the vertical deviations of a real surface from its ideal form. The roughness refers to surface micro-roughness which may be different than measurements of large scale surface variations. In some embodiments, this may be measured using atomic force microscopy (AFM).

In some embodiments, the membrane has an average surface roughness (Rₐ) of 30 to 80 nm, preferably 35 to 75 nm, preferably 40 to 70 nm, preferably 45 to 65 nm, preferably 50 to 60 nm, or even more preferably about 50 nm. In some further embodiments, the anti-fouling properties were enhanced compared to the polysulfone-based support, as determined by y bovine serum albumin (BSA) test.

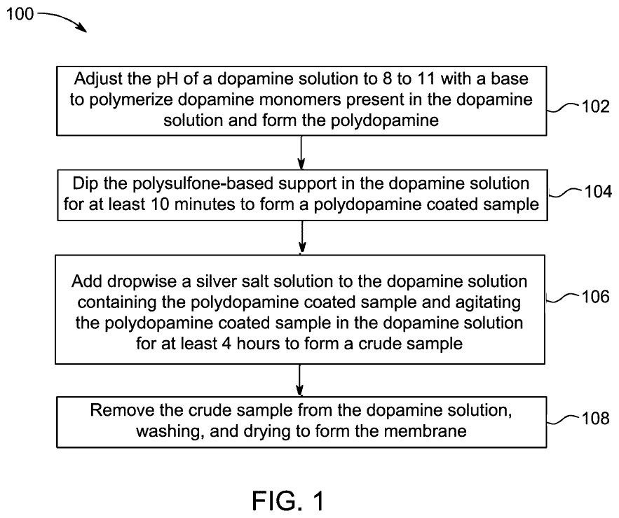

Referring to FIG. 1, a schematic flow diagram of a method 100 of making the membrane 100 is illustrated. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

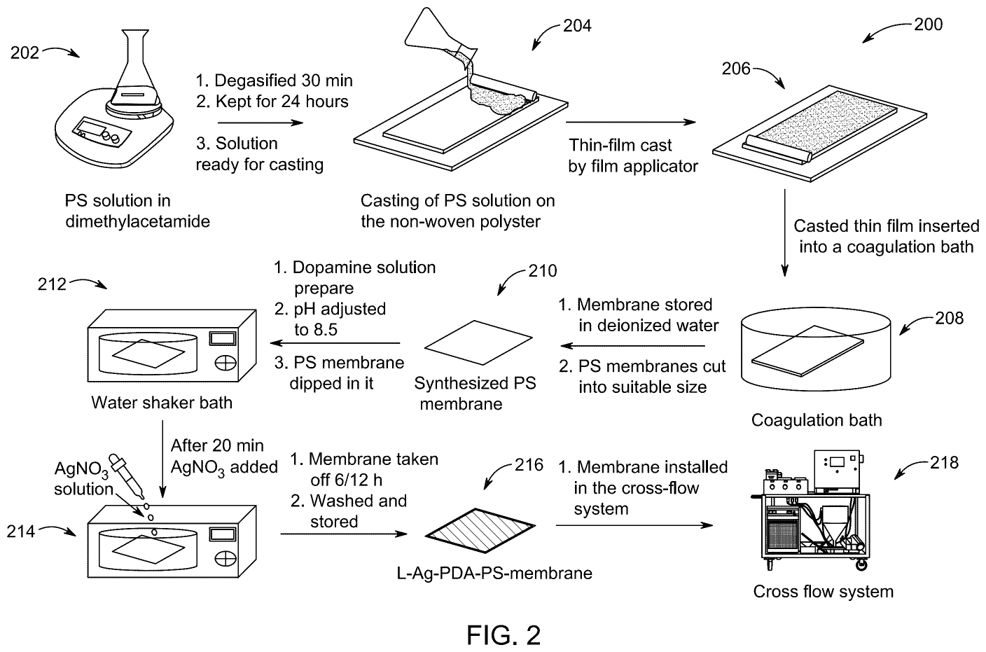

At step 102, the method 100 includes adjusting the pH of a dopamine solution to 8 to 11 with a base to polymerize dopamine monomers present in the dopamine solution and form the polydopamine, as depicted in FIG. 2. In some embodiments, the base is at least one selected from the group consisting of NaOH, KOH, LiOH, and Ca(OH)₂. In a preferred embodiment, the base is NaOH. In some embodiments, the degree of polymerization is pH-dependent, and the polymerization rate can be controlled by adjusting the pH. In some embodiments, at least 50% of the dopamine monomers are polymerized to form the polydopamine, preferably at least 60%, preferably at least 70%, preferably at least 80%, preferably at least 90%, or even more preferably at least 95% of the dopamine monomers are polymerized to form the polydopamine. Other ranges are also possible. In a preferred embodiment, the base is used to preferably adjust the pH of the dopamine solution to about 8.5. Another factor that affects the performance/thickness of the membrane is the concentration of the dopamine solution. In an embodiment, dopamine is present in the dopamine solution at a concentration of 0.05 to 1 wt. %, preferably about 0.1 to 0.5 wt. %, or even more preferably about 0.25 wt. % based on the total weight of the dopamine solution. Other ranges are also possible.

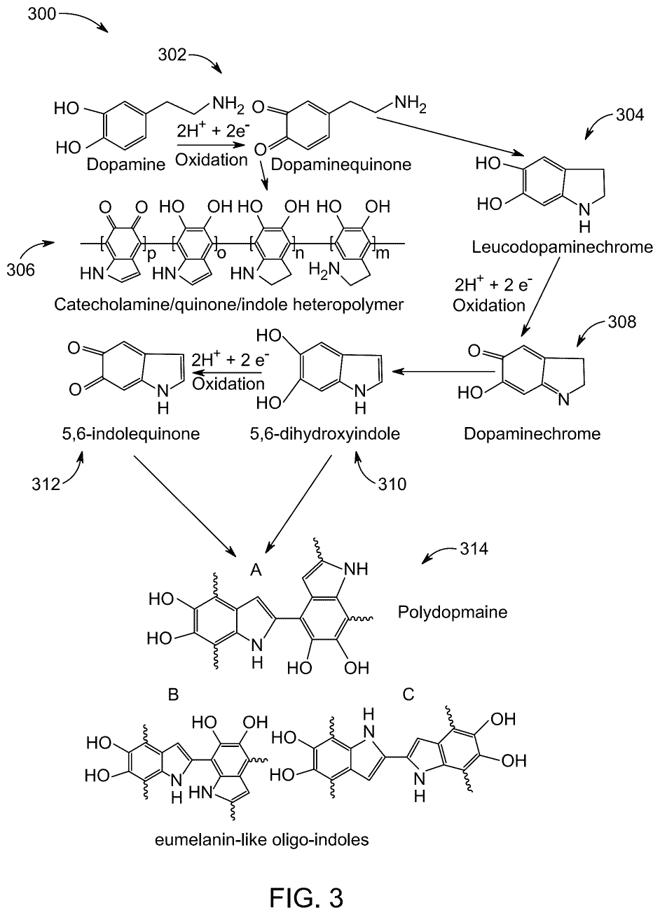

FIG. 3 illustrates a chemical reaction to form polydopamine from dopamine monomers on the polysulfone surface (300). In one embodiment, dopamine is oxidized to dopamine-quinone (302). The dopamine-quinone (302) may be converted into leucodopaminechrome (304) by adjusting pH. In one embodiment, the dopamine-quinone (302) may polymerize to form the catecholamine/quinone/indole heteropolymer (306). In one embodiment, the leucodopaminechrome (304) may form dopamine-chrome (308). In one embodiment, the dopamine-chrome (308) may form 5,6-dihydroxyindole (310), which may be further oxidized to form 5,6-indolequinone (312). In some embodiments, the reverse dismutation reaction's cross-linking of the 5,6-dihydroxyindole (310)/5,6-indolequinone (312) and the catechol may afford the formation of polydopamine (314) as depicted in FIG. 3.

At step 104, the method 100 includes dipping the polysulfone-based support in the dopamine solution for at least 10 minutes to form a polydopamine-coated sample (212), as depicted in FIG. 2. The immersion period is yet another critical factor that affects the performance of the membrane. In an embodiment, the polysulfone-based support is immersed in the dopamine solution for about 10-30 minutes, preferably 15-25 minutes, and more preferably for about 20 minutes to form the polydopamine-coated sample. In yet another embodiments, the polysulfone-based support may be immersed in the dopamine solution for at least 10 minutes, preferably at least 30 minutes, or even more preferably at least 60 minutes to form the polydopamine-coated sample. Other ranges are also possible. In some embodiments, the polysulfone-based support includes one or more polymers selected from PSU, PES/PESU, and PPSU. In a preferred embodiment, the polysulfone-based support is a polysulfone polymer. In some more preferred embodiments, the polysulfone-based support is a polysulfone polymer in the form of a membrane having a contact angle of 60 to 70°, preferably 62 to 68°, preferably 64 to 66°, or even more preferably about 65°. Other ranges are also possible.

At step 106, the method 100 includes dropwise adding a silver salt solution to the dopamine solution containing the polydopamine-coated sample and agitating the polydopamine-coated sample in the dopamine solution for at least 4 hours to form a crude sample (214), as depicted in FIG. 2. In some embodiments, the silver salt is at least one selected from the group consisting of silver nitrate, silver sulfate, silver carbonate, and silver chloride. In a preferred embodiment, the silver salt is silver nitrate. The concentration of silver nitrate is a critical factor affecting the performance of the membrane. In an embodiment, the silver salt is present in the silver salt solution at a concentration of 0.0001 to 0.01 M, preferably 0.001 to 0.008 M, preferably 0.003 to 0.006 M, or eve more preferably about 0.005 M. Optionally, other metal salts of iron, zirconium, silica, aluminum, titanium, and magnesium. gold, platinum (Pt), and palladium (Pd), may be added to the dopamine solution to form the crude sample. The silver salt reacts with dopamine and polydopamine to form the Ag/PDA composite layer. The Ag/PDA composite layer is disposed on the surface of the polydopamine-coated sample. The polydopamine-coated sample was further agitated for about 4-15 hours, preferably 6-12 hours, to form the crude sample. Other ranges are also possible.

At step 108, the method 100 includes removing the crude sample from the dopamine solution, washing, and drying to form the membrane (216), as depicted in FIG. 2. The membrane may be washed with water, or a mixture of water and alcohol (ethanol or isopropanol), and further dried to allow for the evaporation of solvents. The drying may be via air drying, vacuum drying or oven drying.

In another exemplary embodiment, referring to FIG. 2 a schematic illustration of a method of making the PS membrane is described (200). In some embodiments, the polysulfone-based support is a polysulfone membrane. The polysulfone membrane may be prepared by casting a polysulfone solution on a thick non-woven polyester, by the phase inversion process. The method of preparing the polysulfone membrane includes mixing and dissolving solid particles of polysulfone in an amide solvent, and degassing to form a polysulfone solution (202). In some embodiments, the solid particles of polysulfone may be PSU, PES/PESU, and PPSU. Suitable examples of the amide solvent to dissolve the polysulfone include N-methyl pyrrolidone, dimethyl acetamide (DMAC), dimethyl acrylamide (DMAD), dimethyl sulfoxide, or the like. In a preferred embodiment, the amide solvent is DMAC. The concentration of the polysulfone in the polysulfone solution may be adjusted based on the desired flux. This optimization may be obvious to a person skilled in the art. In a preferred embodiment, the concentration of polysulfone in the polysulfone solution is 5 to 40 wt. %, preferably 10 to 30 wt. %, and more preferably about 15 to 25 wt. %, based on the total weight of the polysulfone solution. Other ranges are also possible. The polysulfone solution was subjected to the de-gassing/de-aeration process to remove the air trapped in the dissolution process. This is critical as the presence of air bubbles in the polymer solution can lead to the appearance of discontinuities and implicit defects in the membrane structure in the filming process. The de-gassing may be carried out by ultrasonic means, or by any other conventional methods known in the art. De-aeration/de-gassing was achieved by standing in a closed vessel for 48 h.

Further, the method of preparing the polysulfone membrane also includes drop casting the polysulfone solution on a non-woven support to form a sample (204). In an embodiment, the non-woven support is a polyester non-woven support (206). In some embodiments, the concentration of the polysulfone in the polysulfone solution may affect the thickness of the film in the sample. Optionally, other techniques such as dip coating, spin-coating, bar coating, knife coating, and doctor blading techniques may be employed to form the sample. The sample was further dipped in water to form the polysulfone membrane on the non-woven support (208). In some embodiments, the sample may be dipped in a bath consisting of water and alcohol (for example, ethanol) to form the polysulfone membrane. The samples may be immersed for a period of 5-60 minutes, preferably about 10-30 minutes, more preferably about 10 minutes, to form the polysulfone membrane. The polysulfone membrane was further removed from the non-woven support, washed, and dried for further processes (210). The drying is carried out to allow for the evaporation of the solvent. The prepared polysulfone membrane is hydrophilic with a contact angle of less than 90 degrees)(°, preferably between 50 to 80° and more preferably about 60°.

In yet another exemplary embodiment, a water treatment method is described. The water treatment method involves contacting a contaminated aqueous composition containing one or more organic dyes and one or more salts with the membrane to adsorb the organic dyes on the membrane and form a purified aqueous composition. In some embodiments. the water may be industrial wastewater/household wastewater. For this purpose, the contaminated aqueous composition containing one or more organic dyes and one or more salts can come in contact with the membrane. In some further embodiments, the membrane is prepared by the aforementioned method 100. The organic dyes may include azo dyes such as Erichrome Black T (EBT), and methylene blue. In some embodiments, the organic dye may have a molecular weight in a range of 200 to 1000 g/mol, preferably 300 to 800 g/mol, preferably 400 to 600 g/mol or even more preferably about 500 g/nol. Other ranges are also possible. In a preferred embodiment, the organic dye is EBT. One or more salts include one or more divalent ions selected from the group consisting of Ca²⁺, Cu²⁺, Ni²⁺, Mg²⁺, Zn²⁺, Ba²⁺, Fe²⁺, and Sr²⁺. The membrane, on contact with the contaminated aqueous composition, selectively adsorbs (rejects) the organic dyes on the membrane and forms a purified aqueous composition.

In some embodiments, the water treatment may be performed at a pressure of about 1 to 6 bars, preferably about 1 to 3 bars, or even more preferably about 3 bars. In some embodiments, the organic dye is present in the contaminated aqueous composition at a concentration of 1 to 200 parts per million (ppm), preferably 5 to 100 ppm, preferably 10 to 50 ppm, or even more preferably about 25 ppm. Other ranges are also possible. In some further embodiments, the salt is present in the contaminated aqueous composition at a concentration of 100 to 5000 ppm, preferably 500 to 4000 ppm, preferably 1000 to 3000 ppm, or even more preferably about 2000 ppm. Other ranges are also possible. In some preferred embodiments, one or more salts include one or more counter ions selected from the group consisting of halogen ion, sulfate ion, sulfide ion, phosphate ion, nitrate ion, carbonate ion, and bicarbonate ion. In a preferred embodiment, the counter ion is sulfate ion.

In some embodiments, the membrane is at least one of a polysulfone membrane, a polydopamine coated polysulfone membrane, and a silver/polydopamine coated polysulfone membrane. In one embodiment, the polysulfone membrane has an average surface roughness (Rₐ) of 20 to 40 nm, preferably 25 to 35 nm, or even more preferably about 30 nm. In a further embodiment, the polydopamine coated polysulfone membrane has an average surface roughness (Rₐ) of 4 to 15 nm, preferably 6 to 14 nm, or even more preferably about 8 to 13 nm. In a further preferred embodiment, the silver/polydopamine coated polysulfone membrane has an average surface roughness (Rₐ) of 30 to 80 nm, preferably 40 to 75 nm, or even more preferably about 50 to 70 nm. Other ranges are also possible.

Filtration test is conducted on a crossflow setup consisting of 1 to 10 filtration cells, more preferably 3 filtration cells, built by the Sterlitech company. In some embodiments, the filtration cells are arranged in parallel and spaced apart. In some embodiments, a first end of each filtration cell is in fluid communication with the contaminated aqueous composition containing one or more organic dyes and one or more salts. In some further embodiments, a second end of each filtration cell is in fluid communication with the purified aqueous composition. In some more preferred embodiments, a membrane may be fit into the filtration cell, and each filtration cell contains at least one membrane. In some most preferred embodiments, a portion of the EBT dye/salt containing mixture is introduced into the filtration cell via the first end to at least partially separate an Erichrome Black T (EBT) dye from an EBT dye/salt containing mixture by rejecting the EBT dye, thereby allowing the EBT dye/salt containing mixture to pass through the membrane and form the purified aqueous composition via the second end of the filtration cell.

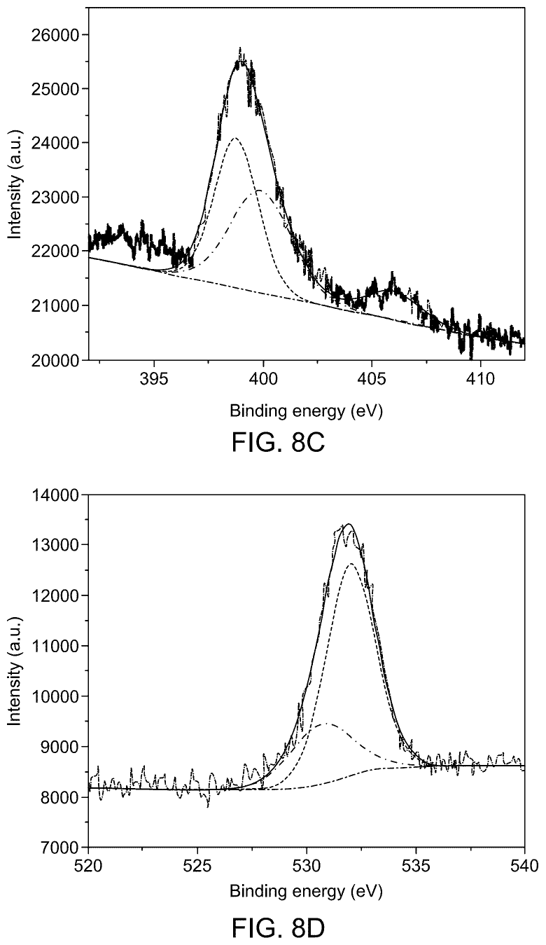

FIG. 10B illustrates a percentage of dye rejection of a membrane at a pressure of 1 to 3 bars. The rejection rate may be calculated according to a formula (I), in which Cₚ is the concentration of the contaminant in the permeate (purified aqueous composition) stream, C_{f} is the concentration of the contaminant in the feed (contaminated aqueous composition) stream.

$$Rejection rate = ( 1 - ( {C}_{p} / {C}_{f} ) ) \times 100 \% \qquad ( I )$$

In some embodiments, the membrane has a dye rejection rate of at least 85%, preferably at least 90%, or even more preferably at least 99% as depicted in FIG. 10B.

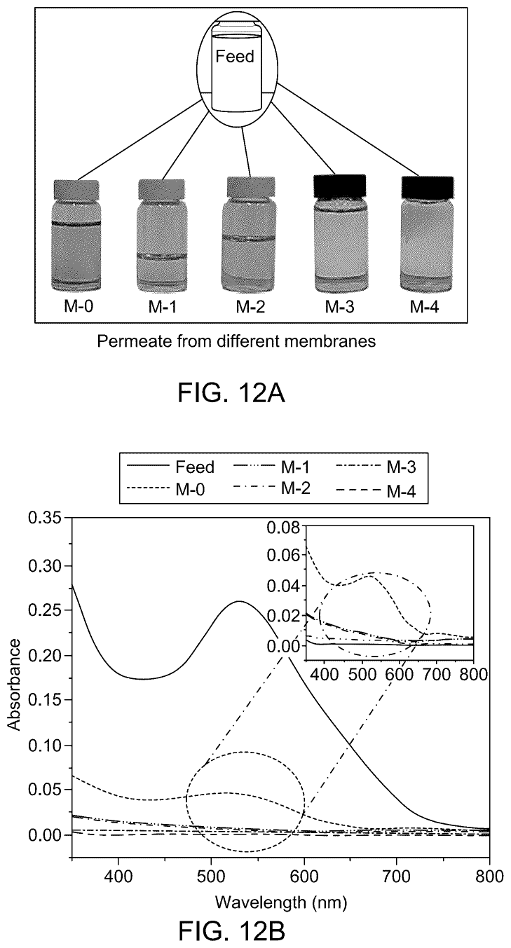

FIG. 13 illustrates a percentage rejection of dye and divalent salt for a membrane. In some embodiments, the dye is EBT, and the salt is MgSO₄. In some embodiments, the membrane has a MgSO₄ rejection rate of 1 to 75% at an EBT rejection rate of at least 90%. In some further embodiments, the membrane has a MgSO₄ rejection rate of 1 to 45% at the EBT rejection rate of at least 90%. In some preferred embodiments, the membrane has a MgSO₄ rejection rate of 1 to 15% at the EBT rejection rate of at least 90%. In some most preferred embodiments, the membrane has a MgSO₄ rejection rate of 1 to 5% at the EBT rejection rate of at least 90%. Other ranges are also possible.

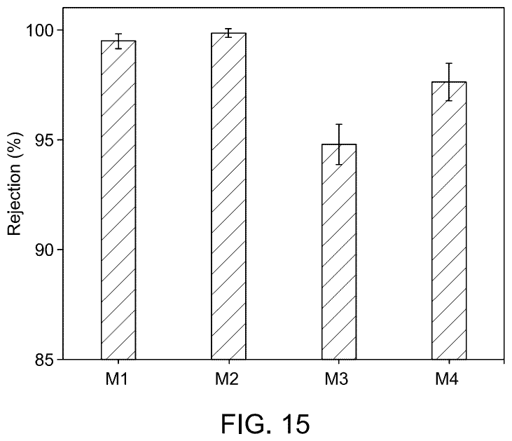

FIG. 15 illustrates a percentage rejection of the EBT dye for a membrane after 6 hours of the fouling experiments, at a pressure of 2 bars. In some embodiments, fouling experiments may be conducted under static and dynamic conditions. The static condition may include a gram-negative bacteria species, and the dynamic condition may include BSA in a cross-flow operating mode. In some further embodiments, long-term fouling experiment is conducted in the presence of BSA. The membrane of the present disclosure fractionates the dye from a dye/divalent salts containing mixture. In some preferred embodiments, the membrane has an EBT rejection rate of about 90 to 100% after the fouling experiments as depicted in FIG. 15.

### EXAMPLES

The following examples demonstrate the polysulfone-based membrane, as described herein. The examples are provided solely for illustration and are not to be construed as limitations of the present disclosure, as many variations thereof are possible without departing from the spirit and scope of the present disclosure.

### Example 1: Materials

Polysulfone, AgNO₃, MgSO₄, EBT, dimethylacetamide, dopamine, and TWEEN®80 were purchased from Sigma Aldrich. All the chemicals are used without any further purification.

### Example 2: Characterization Techniques

State-of-the-art instrumentation was used to characterize the membranes, namely, pristine polysulfone membrane (PS), PS membrane functionalized with dopamine (Dx), and polysulfone membrane functionalized with dopamine and immobilized with silver (ADx) membranes. A JSM-6610LV scanning electron microscope was used for the morphological analysis of the membranes. The membranes were coated by sputtering with gold in the coater before the examination. Thermo Scientific Nicolet iS5 spectrometer was used to measure the FTIR of the various samples. The surface wettability and the water contact angle were recorded using the Drop Shape Analyzer (DSA25, KRÜSS). The membrane was cut into pieces of 1 cm×1 cm, and the contact angle was measured by placing 5 μL water on the membrane. The ESCALAB 250Xi XPS (manufactured by Thermo Scientific, 168, 3rd Avenue, Waltham, Massachusetts, United States) has been used for the surface chemical analysis of the membranes. Thermo Scientific™ iCAP™ 7000 Series ICP-OES (manufactured by Thermo Scientific, 168, 3rd Avenue, Waltham, Massachusetts, United States) was used to measure the silver ions in the permeate. The ICP-OES instrument was fully equipped with the compact ASX-280 autosampler.

### Example 3: Synthesis of the Polysulfone or PS Membrane

A homogenous solution of 18% PS was prepared in dimethylacetamide. To prepare the PS solution, PS pellets were dried overnight by placing the pellets in an oven under a vacuum at 50° C. The dried PS was dissolved in dimethylacetamide with 12 hours of continuous stirring in an airtight vessel to prepare an 18% weight-by-weight (w/w) homogenous solution of the PS solution (202). The obtained PS solution was further de-gassed for 30 minutes to remove the trapped bubbles by placing it in a sonicator. After de-gassing, the PS solution was kept at room temperature for 24 hours to ensure that all the trapped bubbles were released from the PS solution. A coagulation bath containing de-ionized water at room temperature was prepared. The PS solution was cast on a polyester non-woven support (204). The casting was done by a film applicator to obtain a thin film of an ultrafiltration PS membrane (206). The thin film was immediately dipped into the coagulation bath for solidification (208). After 10 minutes, the ultrafiltration PS membrane was removed from the coagulation bath and transferred into de-ionized water. The PS membrane was kept for 24 hours for complete phase inversion and solvent removal (210).

### Example 4: Fabrication of a Separating Layer on the PS Membrane

A piece of 10 cm×10 cm of the PS membrane, as synthesized by the method described in Example 3, was cut for modification and soaked in the de-ionized water for 12 hours before being subjected to the formation of the separation layer. A 0.25% dopamine solution was prepared in de-ionized water. The pH of the dopamine solution was adjusted at 8.5 with the help of a dilute NaOH solution. The polymerization of the dopamine immediately started as the pH increased to 8.5, and the solution's color began to turn reddish-brown. The PS membrane was directly dipped into the dopamine solution (212). After 20 minutes of dopamine polymerization into polydopamine, the AgNO₃ solution was added slowly and dropwise, under continuous shaking, of the PS-containing dopamine solution in a water shaking bath at room temperature to achieve a final concentration of 0.001 M of AgNO₃ (214). The membranes were kept in the solution containing 0.001M AgNO₃ and 0.25% dopamine under continuous shaking for 6 h and 12 h. Finally, the membrane was removed and thoroughly washed with water to obtain the membrane (L-Ag-PDA-PS membrane) (216). These membranes are referred to as AD6 (membranes kept in the 0.001M AgNO₃ in 0.25% dopamine solution under constant shaking for 6 h) and AD 12 (membranes kept in the 0.001M AgNO₃ in 0.25% dopamine solution under continuous shaking for 12 h), respectively. The PDA-coated membranes were prepared similarly under the same set of conditions, except AgNO₃ doping was absent during the polymerization of the dopamine. These membranes (without surface modification by silver), taken out after 6 and 12 hours, are herein referred to as D6 and D12, respectively. The prepared membrane was used in cross-flow systems for filtration (218).

### Example 5: Filtration Experiments

A cross-flow setup consisting of 3 filtration cells built by the Sterlitech company was used for filtration with the pristine and modified membranes. The membranes were fit into the filtration assembly. At one time, a maximum of three membranes are fixed into the separation assembly to evaluate them under the same set of conditions. All the membranes were compacted for 1 hour before filtration analysis. EBT solution of 25 ppm was prepared in de-ionized water.

The solution of 2000 ppm of the MgSO₄ was prepared in de-ionized water. The filtration analysis was run at different pressures, and the feed temperature was controlled at 23° C. with the help of a re-circulating chiller. The dye concentration of the feed and the permeate were measured using the UV-vis spectrophotometer and the MgSO₄. The total dissolved solids (TDS) were analyzed with the help of Ultrameter II (Myron). The salt rejection was determined by the difference in the TDS of the feed and permeate.

### Example 6: Bacterial Analysis

A strain of bacterial species, P. aeruginosa, was taken from the stored stock and placed at −20° C. in a freezer. The strain was grown overnight on the nutrient agar (NA) plate at 37° C. (Fisher Scientific). The next day a single fresh colony of bacteria was suspended in 100 ml nutrient broth (NB) using a safety cabinet (Labconco Cell Logic) equipped with UV light to avoid contamination and incubated overnight at 37° C. The resulting culture was washed with phosphate buffer saline (PBS) twice using centrifugation (Thermo scientific megafuge 16R, (manufactured by Thermo Scientific, 168, 3rd Avenue, Waltham, Massachusetts, United States)) at 6000 rpm for 5 minutes at a room temperature of 30° C. Then, the culture was re-suspended in sterile water (ASTEL Autoclave USA) with 0.9% NaCl solution (Sigma Aldrich). The optical density (OD) was measured at 650 nm (JASCO V-760 spectrophotometer equipped with chiller Lauda Alpha RA-8) with a value of 0.8, correspondingly ˜107-108 bacteria cfu·ml⁻¹. To test the inhibitory effect of the PS, Dx, and ADx membranes, each membrane was cut to the membrane size of (1×2 cm) and was incubated for 6 h at 37° C. using 100 rpm (wise cube shaker incubator) in a flat bottom. Petri dish plates containing 1 ml of the prepared bacterial suspension were mixed with 9 ml of 0.9% NaCl solution (total volume of 10 ml).

After that, bacterial viability was assessed in membrane pieces with dimensions of 1×2 cm, soaked in 1.5 ml of 2 g/ml NaCl solution in a 2.0 ml tube containing 20 glass beads (2.0 mm diameter). The tubes were shaken using a vortex (Daigger, model Genie2, manufactured by Daigger Scientific, Inc., 1425 McHenry Rd Suite 209, Buffalo Grove, IL 60089, USA) at 2200 rpm for 5 min. The bacterial suspension was serially diluted, and CFUs were determined using nutrient agar (28 g/1000 ml) and incubated overnight at 37° C. The bacterial colonies were counted through a colony-counting automated machine (ProtocoL3 SYNBIOSIS).

The inhibitory rate was assessed by the following:

$$Rate ( \% ) = ( C - T ) / C$$

Where ‘C’ (CFU/mL) refers to bacterial count while uncoated membrane (PS) was used as control, and ‘T’ (CFU/mL) represents the count associated with the coated membrane.

### Example 7: Surface Chemistry

FIG. 3 illustrates the possible chemical reaction of dopamine on the polysulfone surface (300). In brief, dopamine passes to several intermediates to form polydopamine. Firstly, dopamine is oxidized to dopamine-quinone (302), which is further converted into leucodopaminechrome (304). The dopamine-quinone (302) may polymerize to form the catecholamine/quinone/indole heteropolymer (306). The leucodopaminechrome (304) results in the formation of the dopamine-chrome (308). The dopamine-chrome (308), on re-arrangement, forms the 5,6-dihydroxyindole (310),), which on oxidation forms 5,6-indolequinone (312). The reverse dismutation reaction's cross-linking of the 5,6-dihydroxyindole (310)/5,6-indolequinone (312) and the catechol results in the formation of polydopamine (314). The various intermediate and possible structures formed during the polymerization of dopamine are illustrated in FIG. 3.

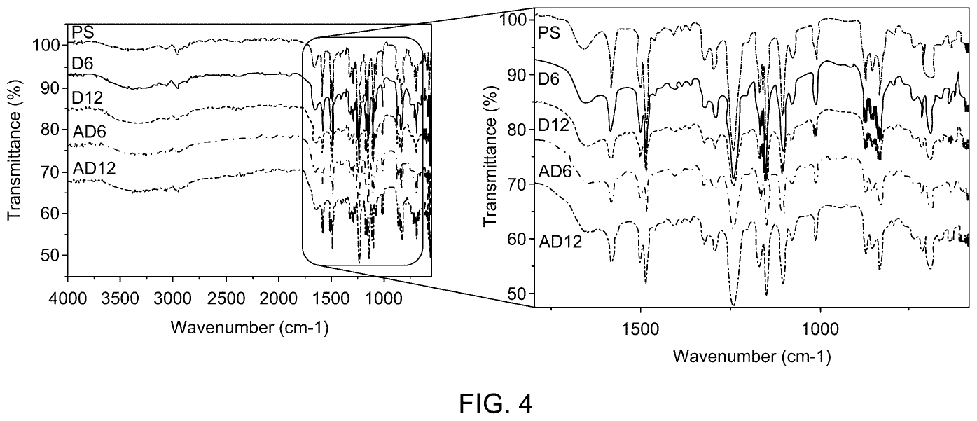

FT-IR spectroscopy in ATR mode was carried out to investigate the surface chemistry of the various membranes. Surface chemistry has played a critical role in separating and controlling the membranes' fouling. FIG. 4 shows the complete spectra for all the membranes (PS, D6, D12, AD6, and AD12) and a magnified view of the footprint region (750-1,750 cm⁻¹). At first glance, all spectra appear very similar, with prominent peaks attributed to the PS layer. The major absorption bands ˜1151 cm⁻¹ (O—S—O stretching), 1244 cm⁻¹ (C—O—C stretching), and 1585 cm⁻¹ (C—C aromatic) are characteristics of the sulfone group. These are almost always visible in the FTIR spectra of polyamide RO membranes. In addition, an intense twin peak at ˜1,500 cm⁻¹ and relatively smaller peaks at ˜1,293 cm⁻¹ (C—O—C) and 1323 cm⁻¹ (O═S═O) were observed. A few minor peaks visible ˜2900 cm⁻¹ are typical of the C—H stretching vibrations emanating from the polydopamine film coated on the PS membrane. Further broadening of the absorption band centered ˜3,300 cm⁻¹ was observed, ascribed to the presence of the v(O—H) and v(N—H) stretching modes. Another notable change after surface modification with the PDA is the further broadening of the —C═C— starching vibrations ˜1650 cm⁻¹.

### Example 8: Contact Angle

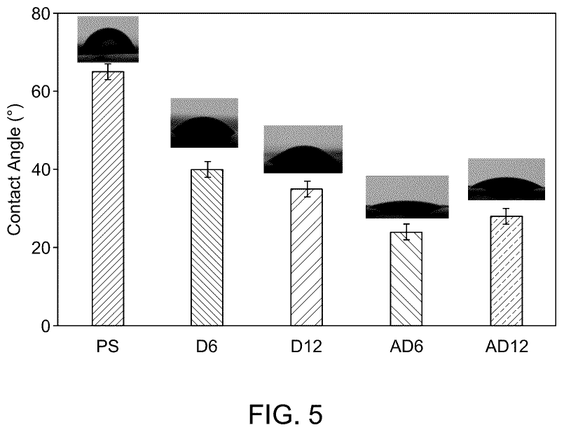

The surface wettability has played a critical role in imparting the anti-fouling behavior and selectivity of the membranes. FIG. 5 shows the average contact angle values for the various membranes. The virgin polysulfone (PS) membrane exhibits an angle of water ˜65°, which agrees with findings in the literature. The relatively hydrophobic nature of this polymer arises from the alkyl groups (CH₃) present in the molecule. The deposition of dopamine on the surface and its subsequent polymerization reduces the contact angle to ˜40°, courtesy of PDA's hydrophilic moieties (OH, NH₂). The slightly lower angle of the D12 membrane compared to the D6 membrane might be explained by the greater degree of polymerization due to the long waiting time. The reduction of silver ions (Ag⁺) and their ultimate immobilization on the PDA surface reduced the contact angle further by ˜10-15°. The nanosilver formed by reducing AgNO₃ is known for its hydrophilic character. Recent studies have shown that water channels form around these nanoparticles that significantly enhance the permeate water flux.

### Example 9: Surface Morphology

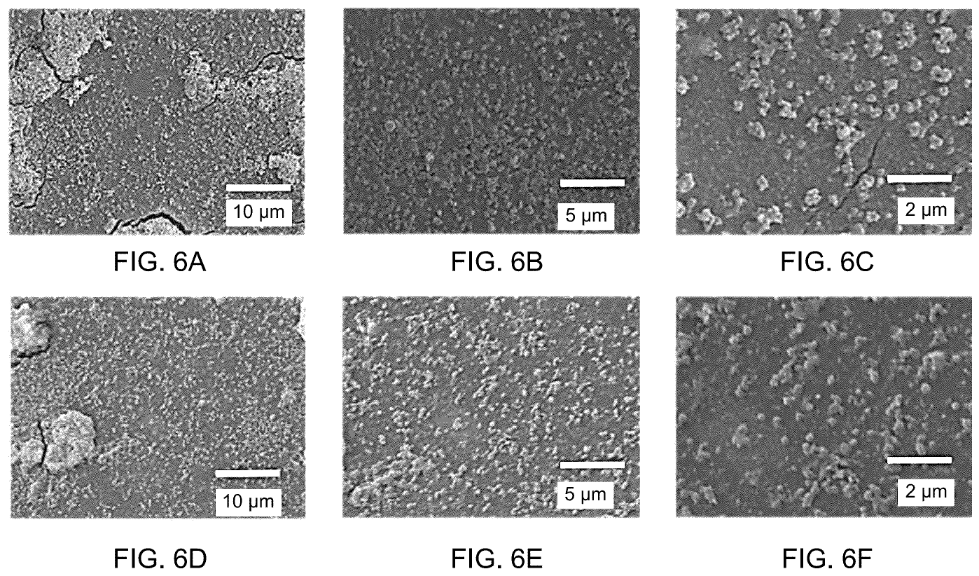

The surface morphology of membranes plays a crucial role in filtration performance and fouling behavior. FIGS. 6A-6F is a collection of SEM images for the membranes modified with silver nanoparticles. FIGS. 6A-6C depict the membrane exposed to dopamine solution for 6 hours, at different magnifications (AD6), while FIGS. 6D-6F are SEM images of the membranes exposed to dopamine solution for 12 hours (AD12). It can be seen that the particles are uniformly distributed throughout the entire surface. From the particle shape on the membrane surface, it is clear that the in situ-produced Ag nanoparticles are immobilized along with the initially formed PDA layer on the surface of the PS membrane. The images at higher magnifications reveal that the distribution is more uniform for the membrane exposed to dopamine for 6 hours (FIG. 6B) compared to the membrane that is exposed to dopamine for 12 hours (FIG. 6E). For the latter, some aggregation of the silver nanoparticles is visible (FIG. 6E and FIG. 6F). As the Ag-containing materials are introduced after the initiation of the polymerization on the surface of the PS membrane, some of the Ag are well-coordinated in a free form with dopamine. Under the basic conditions, the core-shell-like structures are incorporated into the PDA layers along with directly coordinated Ag, resulting in the PDA layer loosening, providing a high permeation flux during the fractionation process.

The dopamine used in anchoring the Ag nanoparticles has two advantages: in alkaline conditions, it undergoes self-polymerization and adheres to any substrate. Secondly, amine and catechol groups enable the in-situ formation and integration of silver nanoparticles. Another critical advantage of using polydopamine is producing silver nanoparticles with better dispersion. Nanomaterial aggregation is a general problem that is considered problematic in achieving a homogeneous dispersion inside the polymer matrices. In addition, the highly irregular distribution of the silver nanoparticles on the membranes may result in poor solute rejection due to numerous defects, severely compromising the membrane performance for the designated application.

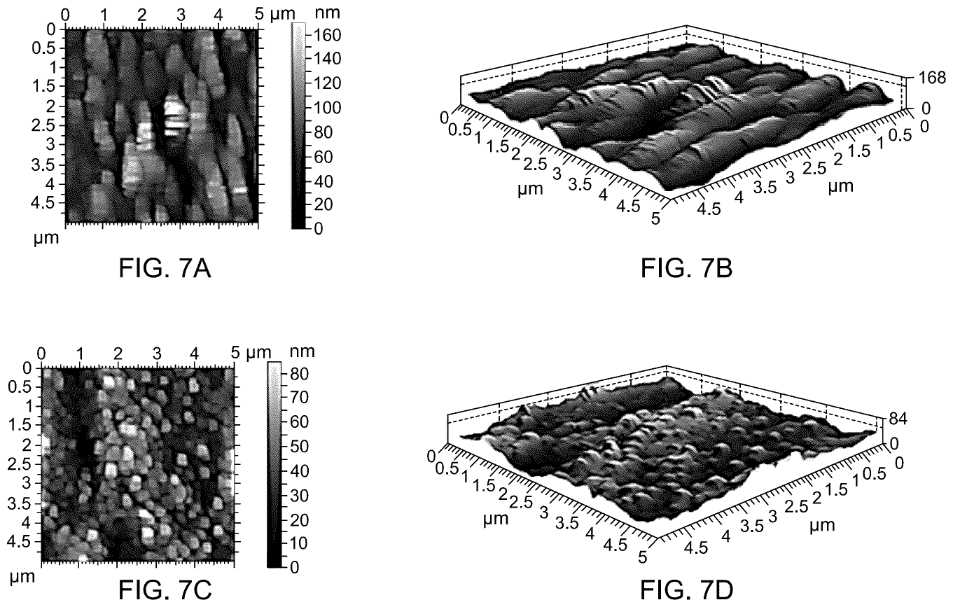

FIG. 7 shows some representative 2D, and 3D AFM images of the PS membrane (FIG. 7A and FIG. 7B). The 2D and 3D AFM images of the D6 membrane are depicted in FIG. 7C and FIG. 7D, respectively; while the 2D and 3D AFM images of the D12 membrane are depicted in FIG. 7E and FIG. 7F, respectively. The 2D and 3D AFM images of the AD12 membrane are depicted in FIG. 7G and FIG. 7H, respectively. All the membranes were scanned for two different areas: 5 & 30 μm². The original polysulfone membrane has an average roughness of ˜30 nm (FIG. 7A and FIG. 7B), which agrees with other studies [Q. Zeng, Z. Wan, Y. Jiang, J. Fortner, Enhanced polysulfone ultrafiltration membrane performance through fullerol Addition: A study towards optimization, Chemical Engineering Journal. 431 (2022) 134071, incorporated herein by reference in its entirety].

Dopamine deposition and subsequent polymerization significantly reduced the roughness with an average value of <10 nm (FIGS. 7B-7E). This may be explained as follows: the original PS surface has some peaks and valleys; when exposed to dopamine, the latter fills up the valleys first and then spreads throughout the entire surface. However, reducing AgNO₃ and the subsequent formation of silver nanoparticles increases the roughness to >50 nm (Table 1). The Ag particles act as ridges or peaks, and their continuous presence on the entire surface makes it rougher. It indicates that AgNPs, along with dopamine, are immobilized on the surface of the membrane. The enhanced surface roughness plays a positive role in providing improved surface area and additional channels for the permeation of the water. The loose layer of Ag-polydopamine on the membranes has shown a capability to perform longer without compromising its performance in flux and rejection.

TABLE 1
The average surface roughness of membranes
at two different scanned areas of 5 & 30 μm²

| | Ra (Average roughness) | Ra (Average roughness) |
|---|---|---|
| Membrane | (5 μm²) | (30 μm²) |
| PS | 26.6 | 32.4 |
| D6 | 6.89 | 13.6 |
| D12 | 4.46 | 7.93 |
| AD12 | 33.1 | 67.5 |

### Example 10: Surface Elemental Analysis

XPS is a valuable tool for analyzing the top 5-10 nm of a surface for the individual elements. XPS analysis of Ag-immobilized samples was crucial to estimate the extent to which the catechol groups of dopamine reduced silver ions. FIG. 8 shows high-resolution spectra for the significant individual elements, carbon (C), silver (Ag), Nitrogen (N), and Oxygen (O). The deconvoluted spectrum of C1s has shown four peaks at binding energies of 284.37, 285.88, 287.69, and 291.33 eV. The peak appeared at the 291.33 eV assigned to the π→π* transitions, 287.69 eV to the C═O and C═N, 285.88 eV to the C—O and C—N, and the binding energy at 284.37 eV designated to the C—H and C—NH₂ (FIG. 8A). The XPS high-resolution spectrum of the Ag 3d has shown the two prominent peaks that relate to the spin-orbit of Ag3d_{5/2} and Ag3d_{3/2}, which on deconvolution, each spin-orbital binding energy split into two. The Ag3d_{5/2} fitted into two bands of the binding energy of 367.92 eV/368.54 eV, and the Ag3d_{3/2} fitted into 373.89/374.47 eV. The binding energy bands at 367.92 eV and 373.89 eV appear due to the Ag₂O, whereas the 368.54 and 374.47 eV peaks indicate the presence of the AgNPs (FIG. 8B). The N1s deconvoluted XPS spectra have revealed the two peaks at 398.8 eV and 399.9 eV. The peaks at 398.8 eV correspond to the tertiary/aromatic (═N—R) amine and 399.9±0.1 eV for secondary amine (R—NH—R) functional groups (FIG. 8C). Apparently, the source of these nitrogen-containing functional groups is from the surface grafted polydopamine. For instance, the tertiary/aromatic peak might be appeared due to the 5,6-dihydroxyindole and 5,6-indolequinone tautomers, whereas the R—NH—R, secondary amine peak co-related to the oxidized intermediate or dopamine. The high-resolution XPS spectra and deconvolution of the O1s have shown two peaks at the binding energy of 530.72 eV and 532.9 eV. The peaks at the binding energy of 530.72 eV may be attributed to O═C and 532.9 eV to O—C. These oxygen-containing groups have been introduced from the tautomeric species or the intermediate species produced during the polymerization and the surface-grafted PDA (FIG. 8D). The detail of these polymeric species can be observed in FIG. 3.

### Example 11: Filtration DI Water Flux

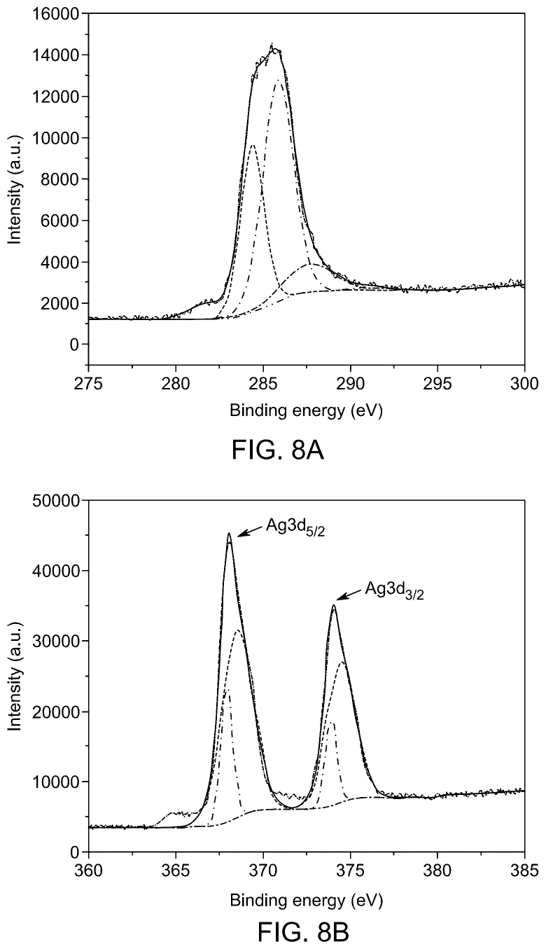

FIG. 9 shows the average flux values with DI water as the feed for the original PS membrane (M-0) and the modified membranes (M-1, M-2, M-3, and M-4 corresponding to D6, respectively) D12, AD6, and AD12 membranes, respectively). The original membrane (M-0) has a very high flux (˜357 LMH), which is expected due to the highly porous nature of the polysulfone. Being an ultrafiltration membrane, the average pore size is typically several tens of nanometers. The high porosity and good mechanical strength are the significant reasons PS is used as a support layer for polyamide RO membranes. The coating of the surface with dopamine (M-1 and M-2) and its subsequent polymerization to form the polydopamine resulted in a more than ten times reduction in the flux, with the average in the range ˜25-28 LMH.

The flux decline was attributed to two factors: (i) an overall increase in the hydraulic resistance of the membrane due to the addition of an extra barrier and (ii) pore size reduction or pore blockage due to PDA deposition. For porous membranes, the 2^{nd} phenomenon is expected to contribute enormously to the observed decrease in water permeance. Similar findings were observed while modifying the poly(vinylidene fluoride) membrane with the PDA. The permeation flux decreased as the PDA polymerized on the surface of the membrane resulting in the narrowing or blockage of the pores of the membranes. Furthermore, among the modified membranes, the ones with Ag particles (M-3 and M-4) exhibit a higher flux than those coated with the PDA alone.

Loose nanofiltration membranes are recognized by their high flux. However, upon exposure to AgNO₃, almost immediately after polymerization initiation, the resulting membrane exhibits a significant increase in permeance; the flux is more than doubled for the sample coated with a 6-hour Ag/PDA film (M-3), registering an average value of ˜71 LMH. Similarly, for the membrane modified with a 12 h dopamine coating, the flux increases from ˜25 to 43 LMH, representing an increase of approximately 70% (M-4). The significant improvement in water permeance is explained primarily by forming a less compact PDA film due to the presence of Ag particles that either attach to the spherical dopamine particles or act as a core for the latter. Another factor is probably the increased surface hydrophilicity due to the formation of Ag particles throughout the surface (as witnessed by contact angle values in FIG. 5). The permeate of the ADx membranes was assessed by using the ICP-OES to observe the stability of the membranes by finding the traces of the silver. In the permeate, no traces of silver were observed, indicating the immobilized Ag's stability through polydopamine on the surface of the PS membrane.

### Example 12: Filtration with Dye

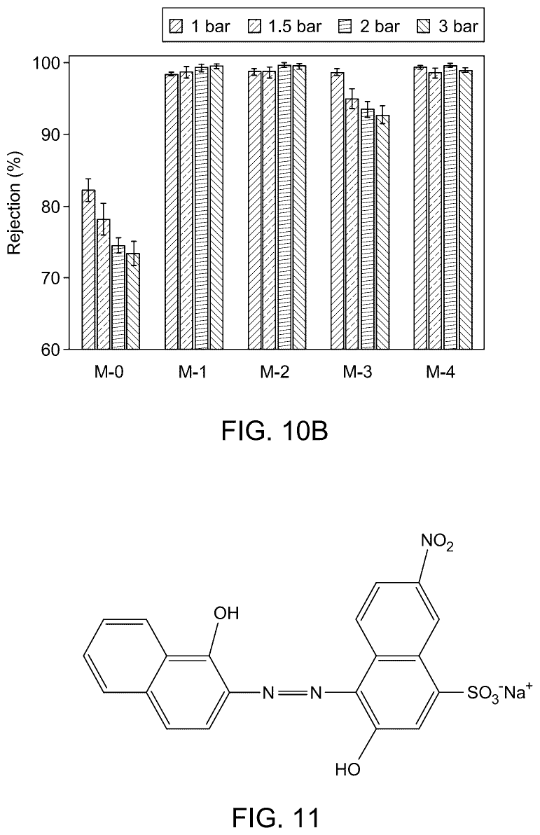

After the preliminary investigations with DI water, filtration experiments were carried out with feed water containing 25 ppm of the dye, EBT. FIG. 10A and FIG. 10B compares the permeate flux and % dye rejection for the original membrane (M-0) and the modified membranes (M-1, M-2, M-3, and M-4 corresponding to D6, D12, AD6, and AD12 membranes, respectively). The flux values agree with those for DI water (FIG. 9). Also, the flux increases almost linearly with the applied pressure for all the membranes, per Darcy's law of permeability. FIG. 10B shows the % dye rejection at the different operational pressures. The original membrane (M-0) rejected only 70-80% of the dye based on the adsorption, not size exclusion. Near-complete removal is observed with the modified membrane. Furthermore, the rejection decreases with increasing pressure for the original ultrafiltration membrane, from a high of ˜82% at 1 bar to ˜73% at 3 bars. On the other hand, for the coated membranes (barring M-3), the rejection is maintained at ˜99% at all pressures. It is evident through the visual inspection and UV-Vis spectra of the permeate of the various membranes (FIG. 12).

The increase in dye rejection after membrane modification, especially for the membranes modified with dopamine only, is best explained by a combination of size exclusion and adsorption mechanisms. The deposition of a compact polydopamine layer significantly reduces pore size due to pore blockage, implying a low molecular weight cutoff (MWCO). The EBT dye has a molecular weight of ˜461 g/mol. The molecular weight cutoff (MWCO) for the polydopamine-coated membranes is probably below this value as it rejects >90% of the dye. In addition, there is a likelihood of dye adsorption on the dopamine layer due to the presence of similar functional moieties (O—H, N) on both sides.

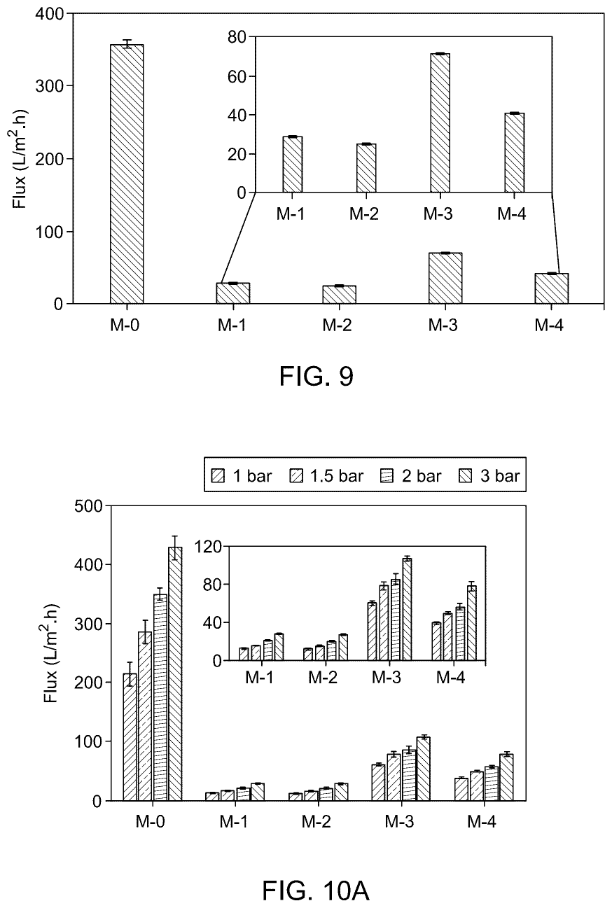

Studies on removing this azo dye using a variety of adsorbents found adsorption to be a dominant mechanism. However, for the membranes modified with silver, electrostatic interactions are a more dominant rejection mechanism than adsorption, as testified by the significantly less EBT adsorption on its surface. In near-neutral conditions, the dye and membranes are negatively charged, the latter due to excess electrons from Ag immobilization on the surface. This resulted in the electrostatic repulsion of the EBT, and later on, less fouling of the membranes was observed during prolonged operation. The structure of the EBT is shown in FIG. 11.

### Example 13: Filtration with Dye and Divalent Salt

Most nanofiltration membranes generally reject a large proportion of relatively high molecular weight organic compounds and dyes such as EBT. However, the dense active layer retains divalent ions such as Mg²⁺, SO4²⁻, etc. Therefore, the tight nanofiltration membranes cannot fractionate the EBT and the divalent states due to poor fractionation performance. For this reason, loose NF membranes are preferred for applications that will retain the organic dye but allow most divalent salt to pass through.

FIG. 13 shows simultaneous rejection values for both EBT and MgSO₄ for the original membrane (M-0) and the modified membranes (M-1, M-2, M-3, and M-4 corresponding to D6, D12, AD6, and AD12 membranes, respectively). The unmodified/original membrane allows near-complete salt passage; however, its dye rejection capability (˜60%) is insufficient for the effective fractionation of the two components. On the other hand, the membranes coated with PDA alone retain almost all of the EBT, yet they reject ˜50% of the divalent ions (M1 and M2). The high rejection of the EBT and divalent salt by the M1 and M2 membranes is due to the formation of the compact PDA layer on the polysulfone membranes. This is because polydopamine has an excellent potential to reject trace contaminants. Still, the primary concern is the potential loss of membrane permeability after forming the PDA layer on the membrane surface. Therefore, additional modification is recommended to enhance the permeability. The L-Ag immobilized polydopamine membranes perform best as they have contrasting rejections for the two components. The M3 membrane rejects ˜95% of the dye, allowing more than 90% of the salt ions to pass through. Similarly, the percentage rejection for the M4 membrane is >99% for EBT and about 14% for MgSO₄.

The trend is explained as follows: the original membrane cannot retain a high proportion of either component due to its larger pore size or high MWCO. The EBT rejected is primarily due to adsorption on the membrane surface, as verified by the color change from white to reddish. On coating the PS membrane with dopamine alone, the latter undergoes self-polymerization, resulting in a compact and dense polydopamine layer that retains large proportions of the dye and salt. The polydopamine film alone is unsuitable for dye/salt fractionation. When AgNO₃ is introduced almost immediately after the initiation of dopamine polymerization, the PDA cannot form a compact layer; instead, it forms either as spherical particles to which the silver particles attach or as a shell layer on the Ag particles. These simultaneous mechanisms form a loose separating layer with an MWCO low enough to retain most of the dye and a sufficiently large pore size that allows the passage of most divalent ions.

### Example 14: Fouling Studies

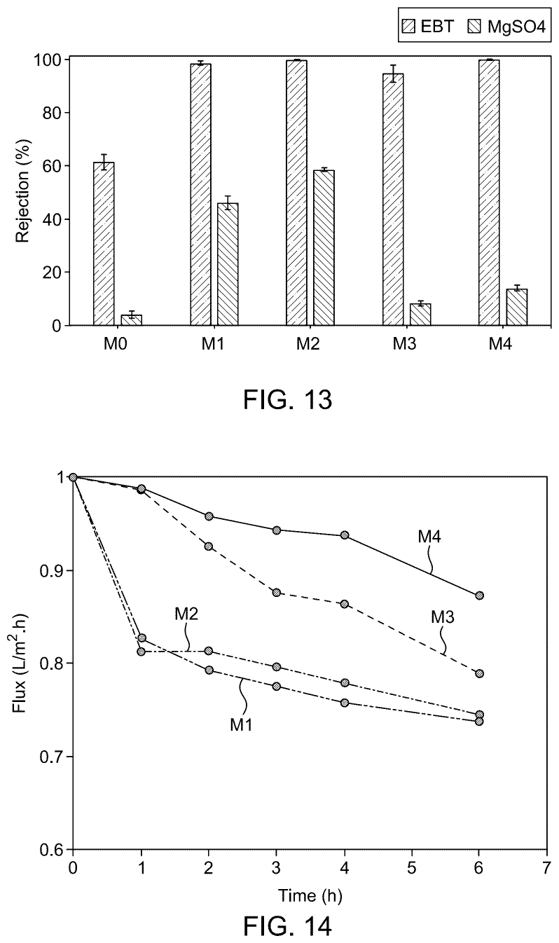

Although the membranes are very effective in water purification, however, have a high tendency to be fouled by organic matter, colloids, and microorganisms present in different feed waters. The consequences of fouling are well-known: permanent decline in permeate flux, increase in the solute passage, etc. Therefore, filtration studies with feed containing 25 ppm of bovine serum albumin (BSA) and the EBT were carried out for 6 hours to determine the fouling-resistant capabilities of the membranes. FIG. 14 shows the variation in permeate flux for all the membranes with time in cross-flow filtration with a 25 ppm EBT feed solution. For the membranes coated with the PDA alone, the flux decline is very rapid during the 1st hour (˜20%) and, after that, more gradual, with the flux reaching ˜75% of the initial value after 6 hours.

The rapid deposition of BSA can explain the above trend in the PDA coating. Due to the presence of catechol groups on the latter, the protein molecules can bind themselves to the surface. As a result, a stable cake layer of the foulants is formed on the surface of the solely PDA-modified membrane. It is usually irreversible and cannot be cleaned by near-surface sheering stress and hydraulic cleaning. Due to this, modifying the PDA can improve the fouling behavior of the membranes. The sulfonated functionalized PDA has been found effective in producing the anti-fouling membranes. The fouling pattern is quite different for the membranes with silver particles immobilized on their surface. The flux decline is very slow during the 1st hour but becomes more rapid in the next couple of hours, especially for the M3 sample. At the end of the 6-hour fouling run, the permeate flux is ˜80% of the original value. The M4 membrane exhibits the most vigorous resistance to fouling, as testified by its slow rate of flux decrease; ˜5% in the first 3 hours and a total of ˜13% in 6 hours.

The presence of Ag particles explains the increased resistance to BSA adsorption and deposition on the PDA surface. The higher adsorption resistance could combine surface hydrophilicity and electrostatic repulsion. As witnessed earlier, the Ag-immobilized membranes are more hydrophilic than the membrane coated with only PDA (FIG. 5). The hydrophilic nano Ag likely discourages or interferes with the adsorption of BSA molecules due to the formation of a hydration layer. Similar trends were observed in investigating different hydrophilic additives in conjunction with dopamine coatings.

FIG. 15 shows the dye retention by the different membranes at the end of the fouling run. The membranes coated with only PDA show near-complete removal, while the % rejection for the samples immobilized with Ag is somewhat lower. In particular, for the M3 sample, the rejection is <95%. This pattern in the rejection can be explained as follows: the PDA coating alone is relatively compact and dense and can retain almost all of the EBT dye. On the other hand. Ag particles present some loose areas that increase the permeate flux (FIG. 9 and FIG. 10) and the passage of small amounts of the dye via solution diffusion.

| | | EBT | Salt | Stability | Flux |
|---|---|---|---|---|---|
| | Flux | Rejection | Rejection | observed | retained/ |
| Membrane | (Lm⁻²h⁻¹bar⁻¹) | (%) | (%) | (h) | hour |
| L-AgNPs-PDA- | 39.2 | 99.9 | 14 | 6 | 87%/6 |
| PS-membrane | | | (MgSO₄) | | |
| (AD 12)^{a} | | | | | |
| PVA- | 38.33 | 97.00% | 26.10% | 12 | 80.1/2 |
| GA/Cu(OH)₂ TFC | | | (MgSO₄) | | |
| NF membrane^{b} | | | | | |
| Helical carbon | 13.3 to 20 | >90.0% | <8.0% | 100 | 93%/100 |
| functionalized | | | (MgSO₄) | | |
| chitosan-based | | | | | |
| loose | | | | | |
| nanofiltration | | | | | |
| membranes^{c} | | | | | |
| ceramic | >25 | >96.8% | 39% | NM | NM |
| membrane^{d} | | | (Na₂SO₄) | | |
| PPTA/PSF | 5.46 | >99% | 98.1 | 12 | 85%/12 |
| particle blended | | | (MgSO₄) | | |
| PA (PIP/TMC)^{e} | | | | | |
| polyamide/ | 10.2 | 100% | 15.2 | 72 | 67%/72 |
| poly(vinylidene | | | (MgSO₄) | | |
| fluoride) | | | | | |
| composite hollow | | | | | |
| fiber membrane^{f} | | | | | |
| GO/PVDF hollow | 11 | 98.9% | 11 | 48 | 72.94%/48 |
| fiber membranes^{g} | | | (Na₂SO₄) | | |
| Polyacrylic Acid- | — | 99% | ~62.85% | NM | NM |
| Grafted PVDF | | | Na₂SO₄ | | |
| Nanofiltration | | | | | |
| Membrane^{h} | | | | | |
| Nanofiltration | 22.7 | 88.8% | 3.5 | 36 | 84.6% |
| membrane based | | | (NaCl) | | |
| on SMA-PEI | | | | | |
| cross-linked | | | | | |
| coatingⁱ | | | | | |

^{a}refers to membrane of the present disclosure;
^{b}refers to Y. Chen, R. Sun, W. Yan, M. Wu, Y. Zhou, C. J. Gao, Antibacterial polyvinyl alcholol nanofiltration membrance incorporated with Cu(OH)₂ nanowires for dye/salt wastewater treatment, Science of The Total Environment. 817 (2022) 152897;
^{c}refers to M. Halakarni, A. Mahto, K. Aruchamy, D. Mondal, S. K. Nataraj, Developing helical carbon functionalized chitosan-based loose nanoliltration membranes for selective separation and wastewater treatment, Chemical Engineering Journal. 417 (2021) 127911;
^{d}refers to P. Chen, X. Ma, Z. Zhong, F. Zhang, W. Xing, Y. Fan, Performance of ceramic nanofiltration membrane for desalination of dye solutions containing NaCl and Na₂SO₄, Desalination. 404 (2017) 102-111;
^{e}refers to W. Shi, T. Li, H. Li, Q. Du, H. Zhang, X. Qin, An attempt to enchance water flux of hollow fiber polyamide composite nanofiltration membrane by the incorporation of hydrophilic and compatible PPTA/PSF microparticles, Separation and Purification Technology. 280 (2022) 119821;
^{f}refers to C. Wang, Chen X. Hu, X. Feng, In-situ synthesis of PA/PVDF composite hollow fiber membranes with an outer selective structure for efficient fractionation of low-molecular-weight dyes-salts, Desalination. 503 (2021) 114957;
^{g}refers to C. Wang, Y. Chen, K. Yang, X. Hu, Y. Zhang, Fabrication of tight GO/PVDF hollow fiber membranes with improved permeability for efficient fractionation of dyes and salts in textile wastewater, Polymer Bulletin. 79 (2022) 443-462;
^{h}refers to Y. H. Chiao, S. T. Chen, M B. M. Y. Ang, T. Patra, D. A. Castilla-Casadiego, R. Fan, J. Almodovar, W. S. Hung, S. R. Wickramasinghe, High-Performance Polyacrylic Acid-Grafted PVDF Nanofiltration Membrane with Good Anti-fouling Property for the Textile Industry, Polymers 2020, Vol. 12, Page 2443. 12 (2020) 2443; and
ⁱrefers to J. Jin, X. Du, J. Yu, S. Qin, M. He, K. Zhang, G. Chen, High performance nanofiltration membrane based on SMS-PEI cross-linked coating for dye/salt separation, Journal of Membrane Science. 611 (2020) 118307, each incorporated herein by reference in their entirety.

From the figure of merit of the designed L-AgNPs-PDA-PS-membrane to the reported literature, it is clear that it has great significance for the fractionation of the EBT and salts with high efficiency. The L-AgNPs-PDA-PS-membrane has shown an unprecedented flux of 39.2 Lm⁻²h⁻¹bar⁻¹ with a substantially high 99.9% rejection of EBT and excellent permeation of divalent salt, making it a better potential candidate for the fractionation of the EBT/divalent salts. The designed membrane is important for the fractionation of the EBT/salts for the industrial process and has excellent utilization to remove the EBT from the wastewater from an environmental perspective, as the EBT is toxic to aquatic life. Its massive release into the environment can significantly damage the ecological system.

### Example 15: Bacterial Testing

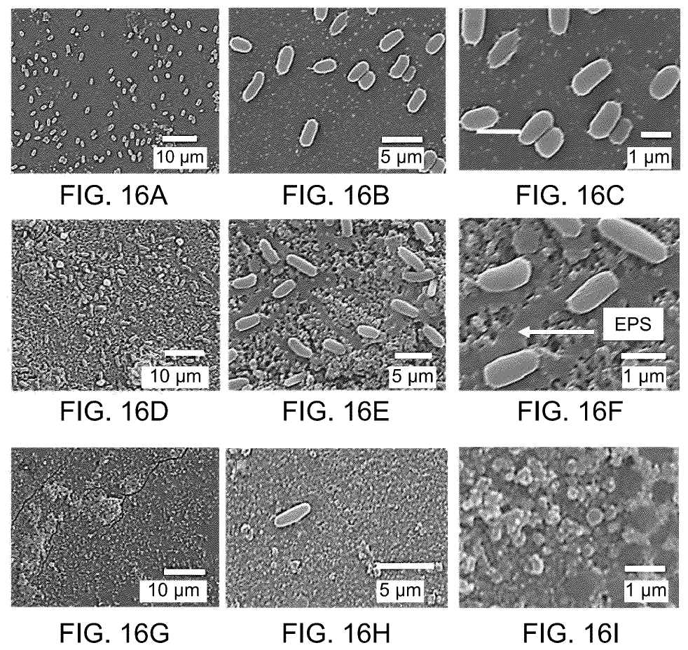

Initial bacterial adhesion is an important early-stage event in the overall process of biofouling. Once attached irreversibly to a surface, the cells can grow, multiply and produce an extracellular polymeric substance (EPS) that acts as a matrix for the bacteria. Therefore, a surface easily colonized by microorganisms is vulnerable to biofilm formation. On the other hand, an anti-adhesive surface that can discourage or delay microbial adhesion is less likely to suffer from biofouling. FIG. 16 is a collection of SEM images of the original and modified membranes after exposure to a bacterial species, P. aeruginosa.

FIGS. 16A-16C depict SEM images of the PS membrane, at different magnifications, after exposure to bacterial suspension of P. aeruginosa. in static conditions; FIGS. 16D-16F illustrate SEM images of the membrane coated with PDA for 6 hours, at different magnifications after exposure to bacterial suspension of P. aeruginosa. in static conditions; and FIGS. 16G-16I depict SEM images of the membrane immobilized with nanosilver and polydopamine at different magnifications after exposure to bacterial suspension of P. aeruginosa. in static conditions.

The images reveal the presence of a high density of bacterial cells on the original membrane (FIGS. 16A-C). This can be explained by the moderately hydrophobic nature of the PS membrane, as testified by its intermediate contact angle, ˜60°. The initial interactions of the bacterial cells with a surface are hydrophobic in nature, with attachment preferred to non-polar and hydrophobic surfaces. After the deposition of the PDA, the propensity for microbial attachment is pretty much similar to bacterial cells depositing very close to each other (FIG. 16D). In fact, the biological activity increases as seen from the presence of an EPS around the cells (FIG. 16E and FIG. 16F). This is surprising, as deposition of the PDA reduced the contact angle to ˜35°. Increased hydrophilicity is usually expected to reduce bacterial attachment to the surface. However, recent studies have shown that simple hydrophilic surface coatings may not effectively prevent or delay microbial attachment. Recent studies reveal that the PDA coatings were ineffective in preventing cell attachment when exposed to bacterial cell suspensions for a long time.

The silver-immobilized PDA particles and their direct immobilization to the PDA coating and the ultimately produced Ag nanoparticles immobilized on the PDA loose layer on the membrane significantly improves the membrane's anti-fouling characteristics. SEM images from different regions show that irreversible attachment of bacterial cells is rare (FIG. 16G-FIG. 16I), indicating the highly anti-adhesive nature of the polydopamine-silver combination. Ag is a well-known antimicrobial; it suggests that the introduced method of forming the Ag/PDA has not compromised its antimicrobial characteristics. Furthermore, the Ag attached to the freely produced PDA particles and their attachment to the PDA layered membrane surface has provided better Ag exposure to the microbes and enhanced the membrane performance.

### Example 16: Mechanism of Fractionation by Developed Loose Membrane

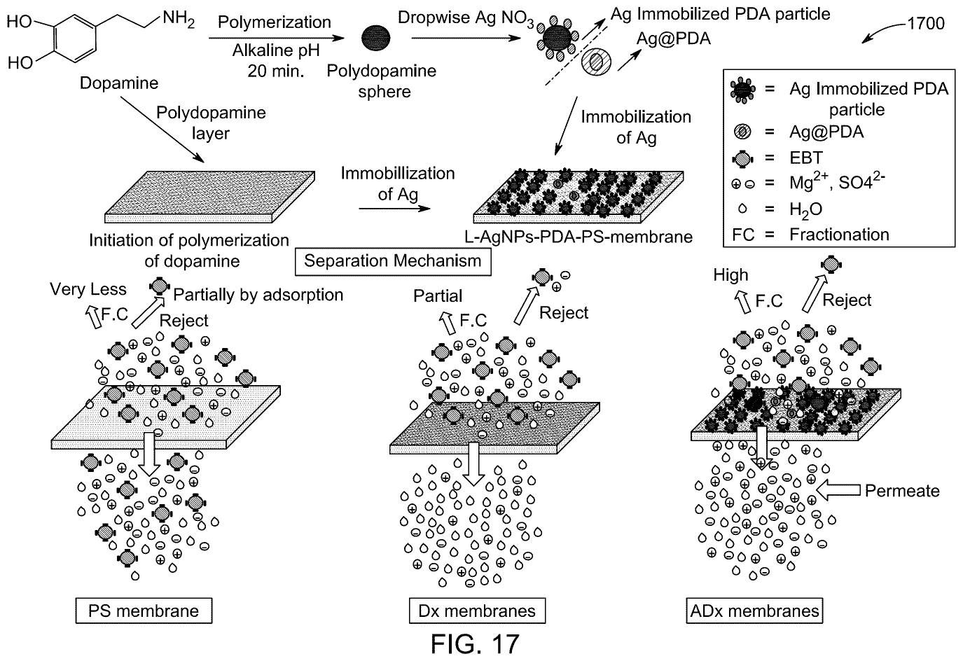

Referring to FIG. 17 is a schematic illustration (1700) depicting the formation of the loose filtration layer through the various combinations of Ag/polydopamine on the surface of the polysulfone membrane, and the separation principle for the various membranes is depicted. The ultrafiltration membranes cannot fractionate the smaller molecules and ions due to their bigger pore size. Removal of some of the dye molecules by the pristine PS was due to their adsorption on the surface of the membrane, which was observed by its color change from white to reddish. The pristine membrane offered no resistance to the ionic salt species, and they moved freely from the membrane under the applied pressure. In the case of PDA layered PS—the PDA has made a compact and tight layer due to the dopamine's self-polymerization, making it an excellent separating layer. The PDA formed a dense layer on the surface of the PS membrane, effectively separating the salts. The polymerization of the dopamine on the substrate slows down substantially, and higher pH of 10.2 was found effective in the oxidation and polymerization of the dopamine. The pH 8.5 was found to be the most suitable one for self-polymerization, and it has been found that the polydopamine firmly sticks to the range of membrane materials. The time-controlled PDA formation at pH 8.5 is highly sticky and is a stable layer on the surface of the PS membrane. The developed compact layer effectively removed the divalent salts and the EBT. Due to this, it is not found suitable for fractionation.

In the case of ADx membranes (AD6 and AD12), AgNO₃ is introduced after the initiation of dopamine polymerization. At the start, the polymerization of dopamine is fast, and it immediately starts sticking to the surface. The addition of AgNO₃ may attach to the surface through three routes-one is it is directly coordinated through initiated polydopamine layer on the membrane surface; secondly, the polydopamine is also being produced in the solution, and Ag might be loaded on the polydopamine particles, which keep immobilizing on the membrane surface during the polymerization of the dopamine on the surface of the membranes. There are also chances of forming core-shell-like structures during the in-situ polymerization and the AgNO₃ reduction. The Ag may act as a core, and the PDA acts as a shell, which may also be immobilized along with the Ag-decorated polydopamine on the PS membrane surface. The polymerization of the dopamine continued and kept interacting with the membrane surface. The incorporation of the Ag and PDA particles into the membrane are not allowed the PDA to form a compact layer on the membrane surface which ultimately result in the formation of the loose separating layer, which has shown great capacity to prevent the EBT permeation and shows no resistance to the MgSO₄ divalent salt.

Furthermore, no prominent dye adherence to the membrane surface was observed compared to the other membranes in the anti-fouling study. Due to the sufficient electronic charge accumulated on the membrane surface due to Ag NPs, immobilization has shown substantial electrostatic repulsion to the negatively charged EBT dye. The separation mechanism and details of the Ag immobilization on the membrane surface are provided in FIG. 17.

Robust membranes exhibiting high dye/salt fractionation efficiency and improved anti-fouling characteristics were synthesized by a facile technique. The initiation of dopamine self-polymerization was immediately followed by the formation of Ag particles by a redox reaction and their ultimate immobilization on the surface of an ultrafiltration membrane. This combination resulted in a relatively loose polydopamine layer capable of retaining the EBT dye and simultaneously allowing the passage of divalent ions. The Ag/PDA membrane rejected >99% of the dye and only ˜14% of MgSO₄, unlike the only dopamine-coated membrane that retained ˜50% of the salt and hence, was unsuitable for fractionation. In addition, due to the loose PDA film on the Ag/PDA membrane, the permeate flux (˜39 LMH/bar) was significantly higher than the membrane coated with dopamine only and membranes cited in the literature for dye/salt fractionation purposes. The surface modification with Ag/PDA increased hydrophilicity (the contact angle reduced from ˜65° to ˜25°) and enhanced anti-fouling characteristics. The rate and extent of fouling by BSA were much lower in these membranes (FD ˜20%) as compared to polydopamine-only membranes (FD ˜30%), which was attributed to both the lower CA value as well as a negative surface charge due to excess electrons from Ag particles. Static bacterial adhesion tests revealed the highly anti-adhesive nature of the Ag/PDA membranes, with very few microorganisms being able to attach to the surface. On the other hand, plenty of bacteria and biofilm patches were visible on the original ultrafiltration membrane and the one coated with polydopamine only. To summarize, the Ag/PDA membrane has the potential for cost-effective and sustainable treatment of waste streams that represent environmental hazards and, more importantly, a waste of resources.

Numerous modifications and variations of the present disclosure are possible in light of the above teachings. It is therefore to be understood that within the scope of the appended claims, the invention may be practiced otherwise than as specifically described herein.

1: A membrane, comprising:
a polysulfone-based support;
wherein the polysulfone-based support has a pore size up to 600 nanometers (nm);
a polydopamine (PDA) layer disposed on a surface of the polysulfone-based support; and
a silver/polydopamine (Ag/PDA) composite layer disposed on a surface of the polydopamine layer;
wherein the Ag/PDA composite layer comprises core-shell structure particles and spherical particles, the core-shell structure particles have a silver nanoparticle core and a polydopamine shell, and the spherical particles are silver-decorated polydopamine particles; and
the membrane separates an Erichrome Black T (EBT) dye from an EBT dye/salt containing mixture by rejecting the EBT dye and allowing the EBT dye/salt containing mixture to pass through the membrane.

2: The membrane of claim 1, having a pore size in a range of 3 to 8 nm.

3: The membrane of claim 1, wherein the polysulfone-based support comprises at least one polymer selected from the group consisting of a polysulfone, a polyethersulfone, and a polyarylethersulfone.

4: The membrane of claim 3, wherein the polysulfone-based support is a polysulfone polymer in the form of a membrane having a contact angle of 50 to 80 degrees (°).

5: The membrane of claim 1, wherein the core-shell structure particles and the silver-decorated polydopamine particles are uniformly disposed on the surface of the polydopamine layer.

6: The membrane of claim 1, wherein the silver-decorated polydopamine particles have a particle size in a range of 50 to 900 nm.

7: The membrane of claim 1, wherein the silver-decorated polydopamine particles are decorated with Ag nanoparticles immobilized on a surface of the spherical particles.

8: The membrane of claim 1, having a contact angle of 20 to 30 degrees (°).

9: The membrane of claim 1, having a permeate flux of 30 to 50 liters per square meter per hour per bar (L m⁻²h⁻¹bar⁻¹).

10: The membrane of claim 1, having an average surface roughness (Rₐ) of 30 to 80 nm.

11: The membrane of claim 1, having an enhanced anti-fouling properties compared to a polysulfone membrane as determined by bovine serum albumin (BSA) test.

12: A method of making the membrane of claim 1, comprising:
adjusting the pH of a dopamine solution to 8 to 11 with a base to polymerize dopamine monomers present in the dopamine solution and form the polydopamine;
dipping the polysulfone-based support in the dopamine solution for at least 10 minutes to form a polydopamine coated sample; then
dropwise adding a silver salt solution to the dopamine solution containing the polydopamine coated sample and agitating the polydopamine coated sample in the dopamine solution for at least 4 hours to form a crude sample;
wherein the silver salt reacts with the dopamine and the polydopamine to form the Ag/PDA composite layer disposed on a surface of the polydopamine coated sample; and
removing the crude sample from the dopamine solution, washing, and drying to form the membrane.

13: The method of claim 12, wherein the base is at least one selected from the group consisting of NaOH, KOH, LiOH, and Ca(OH)₂.

14: The method of claim 12, wherein the polysulfone-based support is a polysulfone polymer in the form of a membrane having a contact angle of 60 to 70°.

15: The method of claim 12, wherein the silver salt is at least one selected from the group consisting of silver nitrate, silver sulfate, silver carbonate and silver chloride.

16: The method of claim 12, wherein the dopamine is present in the dopamine solution at a concentration of 0.05 to 1 wt. % based on a total weight of the dopamine solution.

17: The method of claim 12, wherein the silver salt is present in the silver salt solution at a concentration of 0.0001 to 0.01 M.

18: The method of claim 12, wherein the polysulfone-based support is a polysulfone membrane, further comprising:
preparing the polysulfone membrane by:
mixing and dissolving solid particles of polysulfone in an amide solvent, and de-gassing to form a polysulfone solution;
wherein the polysulfone is present in the polysulfone solution at a concentration of 5 to 40 wt. % based on a total weight of the polysulfone solution;
drop casting the polysulfone solution on a non-woven support to form a sample;
dipping the sample in water to form the polysulfone membrane on the non-woven support; and
removing the polysulfone membrane from the non-woven support, washing and drying.

19: A water treatment method, comprising:
contacting a contaminated aqueous composition containing one or more organic dyes and one or more salts with the membrane of claim 1 to adsorb the organic dyes on the membrane and form a purified aqueous composition.

20: The method of claim 19, wherein the one or more salts comprise one or more divalent ions selected from the group consisting of Ca²⁺, Cu²⁺, Ni²⁺, Mg²⁺, Zn²⁺, Ba²⁺, Fe²⁺, and Sr²⁺.
